(19) United States
(12) Patent Application Publication
(10) Pub. No.: US 2011/0262683 A1
(43) Pub. Date: Oct. 27, 2011

(54) POLYMER ALLOY FIBER AND FIBER STRUCTURE

(75) Inventors: Katsuhiko Mochizuki, Mishima (JP); Yasutaka Kato, Nagoya (JP); Sadanori Kumazawa, Nagoya (JP); Yosuke Onoue, Nagoya (JP)

(73) Assignee: TORAY INDUSTRIES, INC., Tokyo (JP)

(21) Appl. No.: 13/142,161

(22) PCT Filed: Dec. 21, 2009
(86) PCT No.: PCT/JP2009/071209

§ 371 Date: Jul. 11, 2011

(30) Foreign Application Priority Data
Dec. 26, 2008 (JP) 2008-332097

(51) Int. Cl. B32B 5/02; B29C 47/10; D01F 6/44; C08L 25/06

(52) U.S. Cl. 428/97; 525/241; 264/13

(57) ABSTRACT

A polymer alloy fiber includes a polymer alloy consisting of a polylactic acid resin (A), a polyolefin resin (B), and a compatibilizer (C), wherein the compatibilizer (C) is an acrylic elastomer or an styrene elastomer containing at least one functional group selected from the group consisting of anhydride, carboxyl, amino, imino, alkoxysilyl, silanol, silyl ether, hydroxyl, and epoxy, and the polylactic acid resin (A) and the polyolefin resin (B) are island and sea components, respectively, to form a sea-island structure in the morphology of the polymer alloy.

### RELATED APPLICATIONS

This is a §371 of International Application No. PCT/JP2009/071209, with an international filing date of Dec. 21, 2009 (WO 2010/074015 A1, published Jul. 1, 2010), which is based on Japanese Patent Application No. 2008-332097, filed Dec. 26, 2008, the subject matter of which is incorporated by reference.

### TECHNICAL FIELD

This disclosure relates to a polymer alloy fiber produced by blending a polylactic acid resin and a polyolefin resin uniformly wherein the polyolefin resin forms a sea component.

### BACKGROUND

As there has been global change in consciousness of environmental issues in recent years, people have become strongly anxious for development of fiber materials which can decompose in natural environment. For instance, as conventional general purpose plastics are produced mainly from petroleum resources, depletion of petroleum resources likely in the future and global warming due to heavy consumption of petroleum resources have become serious issues.

Accordingly, active efforts have been made in recent years in the field of research and development of aliphatic polyester and other various plastic materials and fibers. In particular, much attention has been drawn to plastics that are decomposed by microorganisms, namely, biodegradable plastics.

If useful materials can be produced from botanical resources, which grow on carbon dioxide taken from atmosphere, they will be expected to serve to depress global warming through cyclic use of carbon dioxide and solve the problem of resources depletion. Thus, attention has been drawn particularly to plastics produced from botanical resources, namely, biomass-based plastics.

Biomass-based biodegradable plastics available in the past has problems such as poor mechanical characteristics, low heat resistance, and high production cost, and did not come in wide use as general purpose plastic materials. Compared to this, recently developed polylactic acid based biodegradable plastics that are produced from lactic acid resulting from fermentation of starch are drawing attention because of their relatively better mechanical characteristics and heat resistance.

Polylactic acid resins produced from polylactic acid or the like have been used from years ago in medical fields as material for surgical suture for instance. As improved mass production techniques have been developed recently, they have become competitive to other general purpose plastics in terms of prices. Accordingly, active efforts are now made at product development to provide materials for fiber.

Development of polylactic acid and other aliphatic polyester fibers has been particularly active in the field of agriculture and construction materials taking advantage of their biodegradability. Expectations are high for increased demands for them in the future as they are applied to the fields of clothing, interior decoration (such as curtains and carpets), vehicle interior finishing, and industrial materials.

Though not plant-derived, polypropylene has been attracting increasing attention as a useful resin. Among other various plastics, polypropylene requires less energy per unit production and has longer life as consumption goods due to their higher durability. In addition, it is also drawing attention as environment-friendly materials as it has good performance features such as good mechanical characteristics, chemical resistance, and dimensional stability, as well as lightness in weight with a specific gravity of 0.9. In the field of fiber, furthermore, it has high competitiveness due to the characteristics described above particularly as material for nonwoven fabrics and other similar products.

On the other hand, aliphatic polyester, such as polylactic acid, and polypropylene have been applied only to limited uses because they have problems as described below.

The low wear resistance of polylactic acid is a major problem when it is used as material for clothing and industrial uses. It has been found that when used to produce clothing, for instance, polylactic acid fiber can easily suffer color migration caused by abrasion and the like, whitening resulting from fibrillation of fibers in extreme cases, and serious stimulation to the skin, leading to poor practical durability. Furthermore, polylactic acid fiber can also suffer flattening and removal of piles and holes in extreme cases when applied to producing automobile interior finishing materials such as carpets and other components that tend to be strongly abraded. It has also been found that aliphatic polyester material (polylactic acid in particular) suffers above-mentioned fibrillation and pile removal, which become more serious over time, due to easy hydrolysis, leading to shorter product life.

As a means of improving the wear resistance of polylactic acid material, processes for depressing hydrolysis, for instance, have been disclosed (Japanese Unexamined Patent Publication (Kokai) No. 2000-136435 and Japanese Unexamined Patent Publication (Kokai) No. 2001-261797). JP '435 depresses hydrolysis during fiber production processes by minimizing the moisture content in polylactic acid material, and JP '797 proposes to add a monocarbodiimide compound in producing hydrolysis resistant fiber. It has been found, however, that the fibers in either case maintain the tendency to fibrillation inherent in polylactic acid material and have not been improved in terms of initial wear resistance as compared with conventional products, though they suffer less abrasion over time as the polylactic acid material is less brittle.

Means of largely improving the wear resistance of polylactic acid fiber has been disclosed (see Japanese Unexamined Patent Publication (Kokai) No. 2004-91968, Japanese Unexamined Patent Publication (Kokai) No. 2004-204406, Japanese Unexamined Patent Publication (Kokai) No. 2004-204407 and Japanese Unexamined Patent Publication (Kokai) No. 2004-277931). They aim to reduce abrasion by adding lubricants such as fatty acid bisamide to decrease the friction coefficient of the fiber surface. However, though these fiber materials work appropriately when applied stress is low, they are not sufficiently resistant adhesive wear when used in materials such as carpets that receive strong forces by users walking on them. Accordingly, the polylactic acid material suffers destruction and, therefore, can be applied only to limited uses.

Polypropylene, on the other hand, is in much smaller use than polyester as material for fibers, although it has very good inherent characteristics. Its major disadvantages include a lower melting point of 165° C. than that of polyester (PET's melting point: 255° C.) and absence of polar groups to serve for dyeing.

Polylactic acid and polypropylene have their respective advantages and disadvantages as described above, have very high potential to provide useful materials if designed to mutually offset their disadvantages. For instance, Japanese Unexamined Patent Publication (Kokai) No. 2008-056743 and Japanese Unexamined Patent Publication (Kokai) No. 2008-111043 propose the use of amine-modified elastomers as compatibilizer for polylactic acid and polyolefin. This method can dramatically improve the compatibility between the two components and serve to produce moldings with dramatically increased elongation percentage, suggesting that it will help producing molded products such as door trim boards and pillar garnish. When processing such a composition into fiber was attempted, however, it required an extremely large stress for elongational deformation after being discharged from nozzles, and could not be processed into fiber through melt spinning, which requires a high draft ratio.

It could therefore be helpful to provide a polymer alloy fiber that is high in wear resistance, small in weight, and high in resilience, and has good appearance after being dyed, and also provide fiber structures produced from the polymer alloy fiber.

### SUMMARY

We provide a polymer alloy fiber comprising a polymer alloy consisting of a polylactic acid resin (A), a polyolefin resin (B), and a compatibilizer (C), wherein the compatibilizer (C) is an acrylic elastomer or an styrene elastomer containing at least one functional group selected from the group of anhydride, carboxyl, amino, imino, alkoxysilyl, silanol, silyl ether, hydroxyl, and epoxy, and the polylactic acid resin (A) and the polyolefin resin (B) act as island component and sea component, respectively, to form a sea-island structure in the morphology of the polymer alloy, and also by providing a fiber structure comprising fiber containing at least part of the polymer alloy fiber.

We provide a synthetic fiber that has largely improved wear resistance, serves to produce a high-quality fiber structure, and serves as excellent material for general clothing and industrial materials, and also provides a fiber structure.

### BRIEF DESCRIPTION OF THE DRAWINGS

FIG. 1 shows a TEM photograph illustrating the sea-island structure of our polymer alloy fiber.

FIG. 2 shows a SEM photograph of the surface layer of our polymer alloy fiber.

FIG. 3 shows a schematic diagram of a direct spinning and stretching apparatus preferably used for producing our polymer alloy fiber.

FIG. 4 shows a schematic diagram illustrating the cooling initiation point in our production process.

### EXPLANATION OF NUMERALS

1: spinning hopper
2: twin-screw extruder-kneader
3: spinning block
4: spinning pack
5: spinning orifice
6: circular chimney (yarn cooling apparatus)
7: yarn
8: oil feeder 1
9: oil feeder 2
10: stretching roll
11: first heating roll (1FR)
12: second heating roll (1DR)
13: third heating roll (2DR)
14: fourth roll (3DR)
15: wind-up machine
16: cooling air blowout face

### DETAILED DESCRIPTION

The polylactic acid resin (A) is preferably crystalline. The polylactic acid is a polymer composed of —(O—CHCH₃—CO)ₙ— as repeating unit and produced by polymerizing lactic acid based oligomers such as lactic acid and lactide. n represents the polymerization degree and is preferably 800 to 8,000. Lactic acid naturally occurs in two optical isomers: D-lactic acid and L-lactic acid. Accordingly, their polymers include poly(D-lactic) acid comprising D-form alone, poly(L-lactic) acid comprising L-form alone, and polylactic acid comprising both. Polylactic acid decreases in crystallinity and increases in melting point depression as the optical purity of the D- or L-lactic acid in the polylactic acid decreases. The melting point is preferably 150° C. or more, more preferably 160° C. or more, to maintain the heat resistance of fiber. It is still more preferably 170° C. or more, and particularly preferably 180° C. or more.

In addition to the above-mentioned simple mixtures involving the two optically isomeric forms, racemic crystals of stereocomplex-type poly(lactic acid) can be produced by blending the above-mentioned two optically isomeric forms of polymers to produce fiber, followed by high temperature heat treatment at 140° C. or more. Polymers of this type are useful because of their increased melting point of 220 to 230° C. In this case, it is most preferable that the blend ratio between the poly(L-lactic acid) and poly(D-lactic acid) in the polylactic acid resin (A) is 40/60 to 60/40 to maximize the content of stereocomplex type crystals. In addition to the above-mentioned mixture of two optically isomeric polymers, stereocomplex-type crystals can also be produced by using L-D-lactic acid block copolymers composed of both L-lactic acid blocks and D-lactic acid blocks. This is advantageous in that the spinning apparatus can be simplified because only a single polymer component is involved.

For the stereocomplex-type crystals to be produced efficiently melt spinning, it is preferable to add a crystal nucleating agent. Examples of the crystal nucleating agent include talc, layered clay minerals, and substances with high compatibility with polylactic acid such as stearic acid, 12-hydroxystearic acid, stearic amide, oleic amide, erucic amide, methylene-bis-stearic amide, ethylene bisstearic amide, ethylene bisoleic amide, butyl stearate, stearate monoglyceride, calcium stearate, zinc stearate, magnesium stearate, and lead stearate.

Polylactic acid material generally contains residual lactide as low molecular weight residues, but such low molecular weight residues can cause contamination of heaters in the stretching and bulking processes or defective dyeing such as dyeing specks in the dyeing and finishing processes. Furthermore, they can accelerate the hydrolysis of fibers and fiber moldings to cause deterioration in their durability. Accordingly, the content of residual lactide in fiber is preferably 0.2 wt % or less, more preferably 0.1 wt % or less, and still more preferably 0.05 wt % or less.

The polylactic acid resin (A) may be, for instance, a copolymer of lactic acid with a non-lactic component as long as it does not impair the characteristics of polylactic acid. Examples of the copolymerization component include polyalkylene ether glycols such as polyethylene glycol; aliphatic polyesters such as polybutylene succinate and polyglycolic acid; aromatic polyesters such as polyethylene isophthalate; and ester bond-forming monomers such as hydroxycarboxylic acid, lactone, dicarboxylic acid, and diols. These copolymerization components in copolymers preferably account for 0.1 to 10 mol % relative to the total quantity of polylactic acid as long as they do not impair the heat resistance due to a fall in melting point.

The polylactic acid resin (A) may contain modifying agents such as particles, delustering agent, color pigment, crystal nucleating agent, flame retardant, plasticizer, antistatic agent, antioxidant, ultraviolet absorber and lubricant. Example of the color pigment include inorganic pigments such as carbon black, titanium oxide, zinc oxide, barium sulfate, and iron oxide; and organic pigments such as those based on cyanine, styrene, phthalocyanine, anthraquinone, perinone, isoindolinone, quinophtharone, quinacridone, or thioindigo. Similarly, other examples of the modifying agents include particles of calcium carbonate and silica, silicon nitride, clay, talc, kaolin, and zirconium acid, in addition to other various inorganic particles, crosslinked polymer particles, and various metal particles. In addition, polymers including various types of wax, silicone oil, various surface active agents, various fluorine resins, polyphenylene sulfides, polyamides, ethylene-acrylate copolymer, methyl methacrylate polymer, other polyacrylates, various types of rubber, ionomers, polyurethanes, and other thermoplasticity elastomers, may also be added in small amounts.

Lubricants used preferably in the polylactic acid resin (A) include fatty amide and/or fatty ester. The fatty amide include is a compound having two amide bonds in one molecule, such as, for instance, lauric amide, palmitic amide, stearic amide, erucic amide, behenic amide, methylol stearic amide, methylol behenic amide, dimethylol oil amide, dimethyl lauric amide, dimethyl stearic amide, saturated fatty acid bisamide, unsaturated fatty bisamide, and aromatic bisamide. Specific examples include, for instance, methylene biscaprylic amide, methylene biscapric amide, methylene bislauric amide, methylene bismyristic amide, methylene bispalmitic amide, methylene-bis-stearic amide, methylene bisisostearic amide, methylene bisbehenic amide, methylene bisoleic amide, methylene biserucic amide, ethylene biscaprylic amide, ethylene biscapric amide, ethylene bislauric amide, ethylene bismyristic amide, ethylene bispalmitic amide, ethylene bisstearic amide, ethylene bisisostearic amide, ethylene bisbehenic amide, ethylene bisoleic amide, ethylene biserucic amide, butylene bisstearic amide, butylene bisbehenic amide, butylene bisoleic amide, butylene biserucic amide, hexamethylene-bis-stearic amide, hexamethylene bisbehenic amide, hexamethylene bisoleic amide, hexamethylene biserucic amide, m-xylylene bisstearic amide, m-xylylene bis-12-hydroxystearic amide, p-xylylene bisstearic amide, p-phenylene bisstearic amide, p-phenylene bisstearic amide, N,N′-distearyl adipic amide, N,N′-distearyl sebacic amide, N,N′-dioleyl adipic amide, N,N′-dioleyl sebacic amide, N,N′-distearyl isophthalic amide, N,N′-distearyl terephthalic amide, methylene bishydroxystearic amide, ethylene bishydroxystearic amide, butylene bishydroxystearic amide, and hexamethylene bishydroxystearic amide. It may also be an alkyl-substituted fatty monoamide, i.e., either a saturated fatty acid monoamide or an unsaturated fatty acid monoamide having a structure in which the amide hydrogen is replaced with an alkyl group, and its examples include, for instance, N-lauryl lauric amide, N-palmityl palmitic amide, N-stearyl stearic amide, N-behenyl behenic amide, N-oleyl oleic amide, N-stearyl oleic amide, N-oleyl stearic amide, N-stearyl erucic amide, and N-oleyl palmitic amide. The alkyl group may contain a substituent group such as hydroxyl group in its structure, and examples of the alkyl-substituted fatty acid monoamide include, for instance, methylol stearic amide, methylol behenic amide, N-stearyl-12-hydroxystearic amide, and N-oleyl-12-hydroxystearic amide.

Examples of the fatty ester include, for instance, aliphatic monocarboxylates such as lauric acid cetyl ester, lauric acid phenacyl ester, myristic acid cetyl ester, myristic acid phenacyl ester, palmitic acid isopropylidene ester, palmitic acid dodecyl ester, palmitic acid tetradodecyl ester, palmitic acid pentadecyl ester, palmitic acid octadecyl ester, palmitic acid cetyl ester, palmitic acid phenyl ester, palmitic acid phenacyl ester, stearate, cetyl ester, and behenic acid ethyl ester; monoesters of ethylene glycol such as glycol monolaurate, glycol monopalmitate, and glycol monostearate; diesters of glycol such as glycol dilaurate, glycol dipalmitate, and glycol distearate; monoesters of glycerin such as monolauric acid glycerin ester, monomyristic acid glycerin ester, monopalmitic acid glycerin ester, and glyceryl monostearate ester; diesters of glycerin such as dilauric acid glycerin ester, dimyristic acid glycerin ester, dipalmitic acid glycerin ester, and distearic acid glycerin ester; and triesters of glycerin such as trilauric acid glycerin ester, trimyristic acid glycerin ester, tripalmitin acid glycerin ester, tristearate glycerin ester, palmitodiolein, palmitodistearin, and oleodistearin.

Of these compounds, it is preferable to use a fatty bisamide or an alkyl-substituted fatty monoamide. The fatty bisamide and alkyl-substituted fatty monoamide are lower in reactivity of the amide component than other common fatty monoamides, and will not react rapidly with polylactic acid during melt molding. They are commonly high in molecular weight, and accordingly they are high in heat resistance and low in sublimability during melt molding. As a result, they maintain good slip properties without losing the functionality as lubricant. In particular, fatty bisamide is more preferable because of its lower reactivity of the amide component, and ethylene bisstearic amide is still more preferable.

Two or more fatty amides or fatty esters may be used, or fatty amides and fatty esters may be used in combination.

The content of the fatty amide and/or fatty ester is preferably 0.1 wt % or more of the total fiber weight to maintain the characteristics. If the content is too high, it will be difficult to produce fiber with good mechanical properties, or the resulting fiber will be yellowish and will not be dyed to have good colors. Thus, the content is preferably 5 wt % or less. The content of the fatty amide and/or fatty ester is more preferably 0.2 to 4 wt %, and still more preferably 0.3 to 3 wt %.

In relation to the molecular weight of the polylactic acid resin (A), its wear resistance increases with an increasing relative viscosity as compared with the polyolefin resin (B) described later, specifically, with an increasing melting viscosity of the polylactic acid resin (A). Thus, the polylactic acid resin (A) should preferably have a high molecular weight, but it tends to deteriorate in moldability and stretchability during melt spinning if its molecular weight is too high. Its weight average molecular weight is preferably 80,000 or more, and more preferably 100,000 or more to maintain wear resistance. It is still more preferably 120,000 or more. If the molecular weight is more than 350,000, the spinnability and stretchability will decrease as described above, resulting in poor molecule orientation and lower fiber strength. Thus, the weight average molecular weight is preferably 350,000 or less, and more preferably 300,000 or less. It is still more preferably 250,000 or less. The weight average molecular weight is measured by gel permeation chromatography (GPC) and converted in terms of polystyrene.

There are no specific limitations on the production method to be used preferably for the polylactic acid resin (A), but specifically, it may be produced by direct dehydration and condensation of lactic acid under the existence of an organic solvent and a catalyst (direct dehydration and condensation method, see Japanese Unexamined Patent Publication (Kokai) No. HEI-6-6536), by copolymerization and ester interchange reaction of at least two homopolymers under the existence of a polymerization catalyst (see Japanese Unexamined Patent Publication (Kokai) No. HEI-7-173266), or by dehydration of lactic acid to produce cyclic dimers, followed by ring opening polymerization (indirect polymerization method, see Description in U.S. Pat. No. 2,703,316).

The polyolefin resin (B) is an unmodified olefin resin produced through polymerization or copolymerization of olefins such as ethylene, propylene, 1-butene, 1-pentene, 4-methyl-1-pentene, 1-hexene, 1-heptene, 1-octene, 1-decene, 1-dodecene, 1-tetradecene, 1-hexadecene, and 1-octadecene, or olefin-based compounds such as olefin alcohols including vinyl alcohol and its derivatives. It is not an unsaturated carboxylic acid, a derivative thereof, or a modified polyolefin resin that is modified with a vinyl carboxylate or the like. Specific examples include homopolymers such as polyethylene resin, polypropylene resin, poly-1-butene resin, poly-1-pentene resin, and poly-4-methyl-1-pentene resin; and copolymers such as ethylene/α-olefin copolymer and others produced by copolymerizing the former polymers with one or more nonconjugated diene monomers such as 1,4-hexadiene, dicyclopentadiene, 2,5-norbornadiene, 5-ethylidene norbornene, 5-ethyl-2,5-norbornadiene, and 5-(1′-propenyl)-2-norbornene.

The ethylene/α-olefin copolymer is a copolymer of ethylene and at least one α-olefins with a carbon number of 3 or more, preferably 3 to 20, and specific examples of the α-olefin with a carbon number of 3 to 20 include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene, 12-ethyl-1-tetradecene, and combinations thereof. Of these α-olefins, it is preferable to use a copolymer comprising an α-olefin with a carbon number of 3 to 12 from the viewpoint of improving the mechanical strength. In the ethylene/α-olefin copolymer, the α-olefin preferably accounts for 1 to 20 mol %, more preferably 2 to 15 mol %, and still more preferably 3 to 10 mol %.

The polyolefin resin (B) to be used for the polymer alloy fiber is preferably polyethylene resin, polypropylene resin, or poly-4-methyl-1-pentene resin from the viewpoint of easy control of the phase structure, and polypropylene resin is more preferably from the viewpoint of heat resistance.

There are no specific limitations on the production method to be used preferably for the polyolefin resin (B). Generally known methods may be used, and those useful for polyolefin resin include, for instance, radical polymerization, coordination polymerization using a Ziegler-Natta catalyst, anionic polymerization, and coordination polymerization using a metallocene catalyst. When the polyolefin resin (B) is a polypropylene resin, it is preferable to use a polypropylene resin with a high stereoregularity, and it is more preferable to use a polypropylene resin with a high isotacticity from the viewpoint of spinnability, fiber's tensile strength, wear resistance, and heat resistance. With respect to stereoregularity, the isotacticity is preferably 80% or more, more preferably 90% or more, and still more preferably 95% or more.

Polypropylene resins with different stereoregularities may be used in combination. For instance, the use of two or more polypropylene resins in which the isotactic structure is dominant is preferable because it serves for easy production of polymer alloy fiber with a high flowability and heat resistance. High-isotacticity polypropylene resin can be easily produced through coordination polymerization using a Ziegler-Natta catalyst.

The polypropylene resin preferably has a melting point of 150° C. or more, more preferably 160° C. to produce polymer alloy fiber with a heat resistance. It is still more preferably 170° C. or more.

The melt viscosity of the polyolefin resin (B) indirectly represents the molecular weight of the polymer. It should have some degree of melt viscosity because it will only provide a fiber with poor strength if its melt viscosity is too low. In view of its viscosity ratio to the polylactic acid resin (A) described later, the polyolefin resin (B) preferably has a melt flow rate (MFR), which serves as an index representing the melt viscosity, of 30 to 100 g/10 min, more preferably 50 to 90 g/10 min.

The polyolefin resin (B) may contain particles, crystal nucleating agent, flame retardant, and antistatic agent, as well as the above-mentioned lubricants and other additives used preferably with the polylactic acid resin (A).

With respect to the degree of crystallinity as referred to here, a polymer can be regarded as being crystalline if it gives a melting peak in the curve observed by differential scanning calorimetry (DSC). A higher crystallinity is more preferable because it leads to a higher wear resistance, and the crystallinity is represented by the calorific value of the crystal melting peak in DSC curves. The calorific value of the crystal melting peak, AH, is preferably 30 J/g, more preferably 40 J/g, and still more preferably 60 J/g.

The crystal nucleating agent may be, for instance, talc. The talc to be used for fiber production preferably has an average particle diameter of 5 μm or less, and particles with a diameter of 10 μm or more accounts for 0 to 4.5 vol. % or less to maintain high crystal-nucleating performance while serving to produce fiber with good mechanical characteristics. Talc with an average particle diameter of less than 5 μm can have drastically improved performance as crystal nucleating agent because of an increased specific surface area. Thus, the particle diameter of the talc is preferably 4 μm or less and more preferably 3 μm or less. Most preferably, it is 1.5 μm or less. There is no specific lower limit to the average particle diameter of the talc, but it is preferably 0.2 μm or more because the aggregability increases and the dispersibility in the polymer decreases with a decreasing particle diameter. Furthermore, particles with a diameter of 10 μm or more preferably account for 4.5 vol. % or less of the total volume of the talc. If large talc particles are contained, not only the spinnability decreases, but also the resulting fiber will have poorer mechanical characteristics. Thus, the content of the particles with a diameter of more than 10 μm in the total talc material is preferably 0 to 3 vol. %, more preferably 0 to 2 vol. %, and most preferably 0 vol. %.

The particle diameter of talc as described in the items (1) and (2) was determined from the particle size distribution measured by laser diffraction using SALD-2000J supplied by Shimadzu Corporation.

Sorbitol derivatives preferably used as crystal nucleating agent include bisbenzylidene sorbitol, bis(p-methyl benzylidene) sorbitol, bis(p-ethyl benzylidene) sorbitol, bis(p-chlorobenzylidene) sorbitol, bis(p-bromobenzylidene) sorbitol, and sorbitol derivatives produced through chemical modification thereof.

Compounds preferable used as phosphate metal salt and basic inorganic aluminum compound are as described in Japanese Unexamined Patent Publication (Kokai) No. 2003-192883.

Preferable melamine compounds include melamine; substituted melamine compounds produced by replacing a hydrogen atom in the amino group in melamine with an alkyl group, alkenyl group, or phenyl group (Japanese Unexamined Patent Publication (Kokai) No. HEI-9-143238); substituted melamine compounds produced by replacing a hydrogen atom in the amino group in melamine with a hydroxyalkyl group, hydroxyalkyl(oxa-alkyl)n group, or aminoalkyl group (Japanese Unexamined Patent Publication (Kokai) No. HEI-5-202157); deammoniation condensation products of melamine such as melam, melem, melone, and metone; and guanamines such as benzoguanamine and acetoguanamine. Usable melamine compound salts include organic acid salts and inorganic acid salts. Usable organic acid salts include carboxylic salts such as of isocyanuric salt, formic acid, acetic acid, oxalic acid, malonic acid, lactic acid, and citric acid; and aromatic carboxylic salts such as of benzoic acid, isophthalic acid, and terephthalic acid. These organic acid salts may be used singly or as a mixture of two or more thereof. Of these organic acid salts, melamine cyanurate is the most preferable. The melamine cyanurate may be surface-treated with a sol of a metal oxide such as silica, alumina, and antimony oxide (Japanese Unexamined Patent Publication (Kokai) No. HEI-7-224049), surface-treated with polyvinyl alcohol or cellulose ether (Japanese Unexamined Patent Publication (Kokai) No. HEI-5-310716), or surface-treated with an nonionic surface active agent with HLB 1 to 8 (Japanese Unexamined Patent Publication (Kokai) No. HEI-6-157820). There are no specific limitations on the molar ratio between the melamine compound and organic acid, but it is preferable that the salt compound materials do not contain free melamine compound or organic acid molecules that are not in the form of a salt. There are no specific limitations on the production method for the organic acid salts of melamine compounds, but in general, by mixing and reacting a melamine compound with an organic acid in water, followed by removing water by filtration or evaporation and drying to provide crystalline powder. The inorganic acid salts include salts of alkyl sulfonic acid such as hydrochloric salt, nitric salt, sulfuric salt, pyrosulfuric salt, methane sulfonic acid, and ethane sulfonic acid; salts of alkyl benzene sulfonic acid such as para-toluene sulfonic acid and dodecyl benzene sulfonic acid; and others such as sulfamic salt, sulfamic acid salt, phosphate, pyrophosphoric salt, polyphosphoric salt, phosphonic salt, phenylphosphonic salt, alkyl phosphonate salt, phosphorous salt, boric salt, and tungsten salt. Of these inorganic acid salts, polymelamine phosphate, polymelamine phosphate/melam/melem multiple salt, and para-toluene sulfonate are preferable. There are no specific limitations on the molar ratio between the melamine compound and inorganic acid, but it is preferable that the salt compound materials do not contain free melamine compound or inorganic acid molecules that are not in the form of a salt. There are no specific limitations on the production method for the inorganic acid salts of melamine compounds, but in general, by mixing and reacting a melamine compound with an inorganic acid in water, followed by removing water by filtration or evaporation and drying to provide crystalline powder. Production methods for the pyrophosphoric salt and polyphosphoric salt are described in, for instance, Description of U.S. Pat. No. 3,920,796, Japanese Unexamined Patent Publication (Kokai) No. HEI-10-81691, and Japanese Unexamined Patent Publication (Kokai) No. HEI-10-306081.

The content of a crystal nucleating agent has an inverse relation with the mechanical characteristics of the fiber, and accordingly, it is preferably 0.01 to 2 wt % of the total weight of the fiber. When the content is 0.01 wt % or more, the material can crystallize quickly under short-term heat treatment in the fiber production process, thereby producing a polymer alloy fiber with a high fastness. When it is below 2 wt %, a polymer alloy fiber with a high fastness can be produced while depressing the deterioration in mechanical characteristics. The content of a crystal nucleating agent is more preferably 0.05 to 1.5 wt %, and still more preferably 0.2 to 1 wt %.

The compatibilizer (C) is either an acrylic elastomer or a styrene elastomer containing at least one functional group selected from the following: anhydride group, carboxyl group, amino group, imino group, alkoxysilyl group, silanol group, silyl ether group, hydroxyl group, and epoxy group. From the viewpoint of spinnability, diameter stability, strength, wear resistance, and heat resistance, it is preferable that the compatibilizer (C) is either an acrylic elastomer or a styrene elastomer containing at least one functional group selected from the following: anhydride group, amino group, imino group, and epoxy group. It is more preferably a styrene elastomer containing at least one functional group selected from among the anhydride group, amino group, and imino group, and still more preferably a styrene elastomer containing the amino group. As the compatibilizer (C) can acts on the interface between the polylactic acid resin (A) and the polyolefin resin (B), its weight average molecular weight, Mw, has large effect on the boundary separation characteristics. Accordingly, the polymer preferably has a molecular weight of 10,000 or more to have a high resistance to boundary separation, while the molecular weight is preferably 350,000 or less for the polymer alloy to have a high spinnability. It is more preferable for the polymer to have a 30,000 to 250,000. The value of Mw is measured by gel permeation chromatography (GPC) using hexafluoroisopropanol as solvent and converted in terms of polymethyl methacrylate (PMMA).

The compatibilizer (C) contains either a (meth)acrylate vinyl unit or styrene vinyl unit, preferably either a (meth)acrylate vinyl unit or styrene vinyl unit as the primary component with a content of 60 wt % or more, more preferably 80 wt % or more. It may be a copolymer in which a vinyl monomer unit other olefin monomers accounts preferably for 40 wt % or less, more preferably for 20 wt % or less. For the disclosure, when it is a styrene elastomer containing at least one functional group selected from among anhydride group, carboxyl group, amino group, imino group, alkoxysilyl group, silanol group, silyl ether group, hydroxyl group, and epoxy group, furthermore, it contains at least a styrene vinyl unit to maintain a high phase structure controllability, spinnability, strength, heat resistance, and wear resistance (resistance to boundary separation), and its content is preferably 1 to 30 wt %, and more preferably 5 to 15 wt %.

Preferable examples of the monomer to form a (meth)acrylate vinyl unit include methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate, 2-ethylhexyl methacrylate, cyclohexyl acrylate, cyclohexyl methacrylate, isobornyl acrylate, isobornyl methacrylate, acrylonitrile, and methacrylonitrile, of which methyl acrylate, methyl methacrylate, ethyl acrylate, ethyl methacrylate, n-butyl acrylate, n-butyl methacrylate, acrylic acid 2-ethylhexyl, methacrylic acid 2-ethylhexyl, acrylonitrile, and methacrylonitrile are more preferable. These may be used singly or in combination.

Examples of the monomer to form a styrene vinyl unit include styrene, α-methyl styrene, p-methyl styrene, α-methyl-p-methyl styrene, p-methoxy styrene, o-methoxy styrene, 2,4-dimethyl styrene, 1-vinyl naphthalene, chlorostyrene, bromostyrene, divinylbenzene, and vinyl toluene, of which styrene and α-methyl styrene are particularly preferable. These may be used singly or in combination.

Examples of the monomer that forms an epoxy-containing vinyl unit to act as a constituent of the compatibilizer include glycidyl esters of unsaturated monocarboxylic acid such as glycidyl (meth)acrylate and glycidyl p-styrylcarboxylate; monoglycidyl esters or polyglycidyl esters of unsaturated polycarboxylic acid such as maleic acid and itaconic acid; and unsaturated glycidyl ethers such as allyl glycidyl ether, 2-methylallyl glycidyl ether, and styrene-4-glycidyl ether. Of these, glycidyl acrylate and meta-glycidyl acrylate are used preferably from the viewpoint of radical polymerizability. These may be used singly or in combination. Examples of the monomer that forms an anhydride-containing vinyl unit to act as a constituent of the compatibilizer include maleic anhydride, itaconate anhydride, citraconate anhydride, and aconitic anhydride, of which maleic anhydride is particularly preferable. These may be used singly or in combination. Examples of the monomer that forms an unsaturated dicarboxylic acid unit to act as the carboxyl-containing unit include maleic acid, monoethyl maleate, itaconic acid, and phthalic acid, of which maleic acid and itaconic acid are preferable. These may be used singly or in combination. Furthermore, two or more compatibilizers may be used in combination.

As the compatibilizer (C) can acts on the interface between the polylactic acid resin (A) and the polyolefin resin (B), its melt viscosity has large effect on the melt viscosity of the entire polymer alloy and its phase structure. From the viewpoint of spinnability, strength, heat resistance, and wear resistance, therefore, its melt flow rate (MFR) is preferably higher than that of the polyolefin resin (B) to be used. If it has a very high melt viscosity with a MFR of less than 3, on the other hand, the melt viscosity of the entire polymer will increase to cause a deterioration in spinnability, and so it is not preferable. The MFR is more preferably 5 to 20 g/10 min.

In the case where the compatibilizer (C) is an epoxy-containing acrylic elastomer or styrene elastomer, the epoxy value is preferably in the range of 0.1 to 10 meq/g, more preferably 1 to 7 meq/g, and still more preferably 2 to 5 meq/g from the viewpoint of controlling the phase structure of the polymer alloy. The interfacial adhesion between the sea and island components will improve when the epoxy value is 0.1 meq/g or more, while gelation is depressed preferably when the epoxy value is 10 meq/g or less. The epoxy value as referred to herein is measured by the hydrochloric acid-dioxane method. The epoxy value of a polymer incorporating a glycidyl-containing vinyl unit can be controlled by adjusting the content of the glycidyl-containing vinyl unit.

The glass transition temperature of the compatibilizer (C) is preferably in the range of 30 to 100° C., more preferably 40 to 70° C. from the viewpoint of handleability. The glass transition temperature as referred to herein is measured by differential scanning calorimetry (DSC) according to the method described in JIS K7121, and it is an intermediate glass transition temperature determined at a heating rate of 10° C./min. The glass transition temperature of the compatibilizer (C) can be controlled by adjusting the composition of the copolymer. Commonly, the glass transition temperature can be increased by incorporating an aromatic vinyl unit such as styrene in the copolymer, while it can be decreased by incorporating a (meth)acrylate vinyl unit such as butyl acrylate in the copolymer. For the compatibilizer (C), a sulfur compound may be added as a chain transfer agent (molecular weight adjustor) to obtain a low molecular weight polymer, and in this case, the polymer will contain sulfur. The sulfur content is preferably minimized as sulfur will have an unpleasant odor. Specifically, it is preferable that that sulfur atoms account for 1,000 ppm or less, more preferably 100 ppm or less. It is particularly preferably 1 ppm or less.

There are no specific limitations on the production method for the compatibilizer (C), and generally known polymerization method such as bulk polymerization, solution polymerization, suspension polymerization, and emulsion polymerization may be used as long as they meet the requirements specified. When these method are used, a polymerization initiator, chain transfer agent, solvent, or other materials may be added and remain as impurities in the finally obtained compatibilizer (C). The quantity of these impurities should preferably be minimized as they cause a deterioration in heat resistance and light resistance. Specifically, the impurities preferably account for 3 wt % or less, more preferably 1 wt % or less, of the total weight of the finally obtained polymer alloy fiber. For the production of the compatibilizer (C), it is preferable that that continuous bulk polymerization is carried out in a short period of time of about 5 to 30 minutes at a high temperature of 150° C. or more to achieve the characteristics described above.

Examples of the compatibilizer (C) include commercial products such as Arufon supplied by Toagosei Co., Ltd., Joncryl supplied by Johnson Polymer Corp., Clayton supplied by Clayton, Tuftec supplied by Asahi Kasei Chemicals Corporation, and Dynalon supplied by supplied by JSR Corporation. Addition of the compatibilizer (C) serves to improve the affinity between the polylactic acid resin (A) and the polyolefin resin (B), making it easy to control the phase structure. By using this under specific conditions including the melt viscosity ratio between the sea and island components in the materials described below, melt viscosity of the sea component, temperature of the orifice surface, and specifications of the orifice hole, it will become possible to produce a polymer alloy fiber having a high spinnability, depressed diameter unevenness, high strength, heat resistance, and wear resistance.

For the production of the polymer alloy fiber to be performed stably, it is important that the phase structure involving the polylactic acid resin (A) and the polyolefin resin (B) is stable, that is, the size distribution of the island component (polylactic acid resin) is small in the sea-island structure. To ensure quick elongational deformation of the melt along the spin-line, it is also necessary to minimize the deformation ratio of the polylactic acid resin (A), which will form the island component, in the orifice and in addition, promote relaxation of the island component after leaving the orifice. For this, it is preferable that (i) the viscosity ratio (η_{A}/ηr_{B}) between the melt viscosity η_{A} of the polylactic acid resin (A) and the melt viscosity η_{B} of the polyolefin resin (B) is in the range of 1.3 to 10 when they are subjected to melt viscosity measurement at a temperature of 230° C. and a shear rate of 6.1 (sec⁻¹), and (ii) the polyolefin resin (B), which forms the sea component, has a melt viscosity η_{B} of 200 Pa·s or less.

Meeting the first requirement (i) given above makes it possible to further decrease the storage energy in the orifice hole and also decrease the deformation ratio of the polylactic acid resin which forms the island. The deformation ratio of the island domain in the orifice hole has a very close relation with the spinnability, and this deformation ratio is a very important factor in spinning of a polymer alloy fiber consisting of polymers incompatible with each other.

Meeting the first requirement (ii) given above makes it possible to further accelerate the orientation relaxation of the island component along the spin-line, facilitating stable large deformation (high draft ratio) along the spin-line.

With respect to the blend ratio between the polylactic acid resin (A) and the polyolefin resin (B), it is preferable that the polylactic acid resin (A) accounts for 1 to 45 parts by weight while the polyolefin resin (B) accounts for 99 to 55 parts by weight relative to 100 parts by weight accounted for by the total amount of the polylactic acid resin (A) and the polyolefin resin (B) to produce a polymer alloy of a sea-island structure in which the polylactic acid resin (A) and the polyolefin resin (B) form the island and the sea component, respectively. It is more preferable that the polylactic acid resin (A) accounts for 10 to 40 parts by weight, still more preferably 15 to 35. The compatibilizer (C) preferably accounts for 1 to 30 parts by weight relative to the total amount (100 parts by weight) of the polylactic acid resin (A) and the polyolefin resin (B) to serve effectively as a compatibilizer and to show a high fiber-forming performance. It is more preferably 3 to 15 parts by weight and still more preferably 5 to 10 parts by weight.

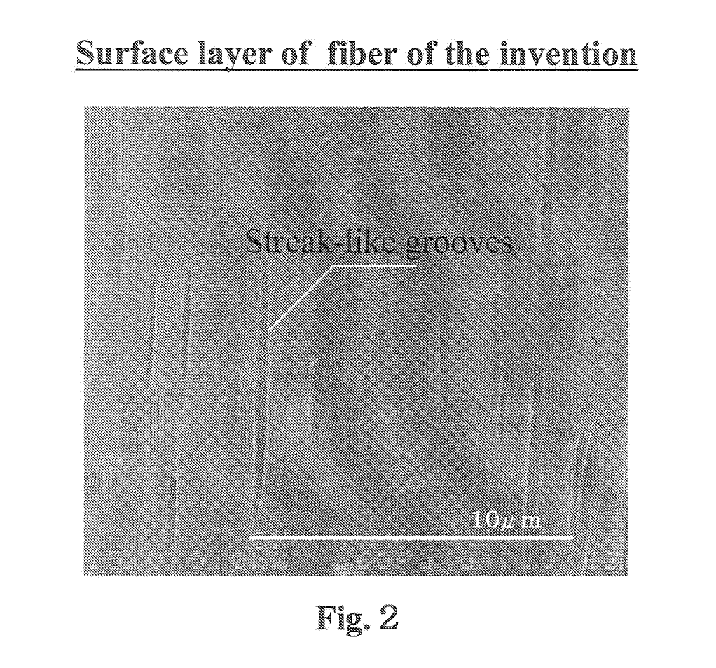

It is preferable that for the polylactic acid resin to be scarcely exposed at the fiber surface (fiber-side surface) of the polymer alloy fiber. It is known that the polylactic acid resin and the polyolefin resin have little compatibility and the adhesive strength at polymer alloy interface is low. Therefore, if the polylactic acid resin is exposed at the fiber surface, cracks would develop from the interface and fibers will suffer fibrillation. If the polylactic acid resin is exposed at fiber surface, it would be almost impossible to distinguish this resin from the olefin resin in observation by optical microscopy or other similar means. For analysis of the exposure of the polylactic acid resin at the fiber surface, the fiber surface may be etched with an alkali solution to dissolve only the polylactic acid resin, followed by observation by electronic microscopy (SEM) to determine the degree of its exposure. Significant fibrillation will not take place if the streak-like grooves left after alkali etching to remove the polylactic acid accounts for 10% or less of the surface area when observed by SEM. For industrial materials that require higher durability, the surface area of the streak-like grooves is preferably 7% or less, more preferably 5% or less. The streak-like grooves are long depressions extending nearly in parallel with the fiber axis (at angles within 10° from the fiber axis) as shown in FIG. 2. Such streak-like grooves can be observed in SEM photographs commonly taken at a magnificent of 5,000, or 1,000 to 10,000 as required. To determine the surface area of the streak-like grooves, SEM observation is carried out with a view angle to cover a 10 μm×10 μm area, and the size of the streak-like grooves are analyzed with a WinROOF image analysis program, followed by calculating the total surface areas of the streak-like grooves contained in the field of view.

In the conventional polymer alloy fibers produced from a combination of a polylactic acid resin (A), a polyolefin resin (B), and a compatibilizer (C), a bulge with a diameter several times that of the discharge hole tends to take place directly below discharge hole due to the so-called ballast effect caused by the interface tension between polymer phases. As a result, the yarn tends to be uneven in diameter as it thins during the spinning process, leading to breakage of the yarn or other quality defects such as uneven properties in the yarn. By setting up appropriate polymer combination conditions as described above including optimum polymer melt viscosity design, the type and viscosity of the compatibilizer used, the orifice surface temperature and orifice back pressure described below, as well as design for the linear discharge speed from the orifice, the fiber can minimize the ballast effect, and even if a bulge is caused by the ballast effect, fiber formation can proceeds stably because an elongational flow with an increased speed can develop in a region as close to the orifice surface as possible. Accordingly, the yarn would suffer only small unevenness in the length direction of the fiber. In filaments or multifilaments produced from the polymer alloy fiber, the yarn unevenness (Uster unevenness, U %, half-inert mode) is preferably 4% or less, more preferably 3% or less, to facilitate the smooth passage through the process and decrease dyeing specks during the dyeing process. It is still more preferably 2% or less. It is most preferably 1.5% or less.

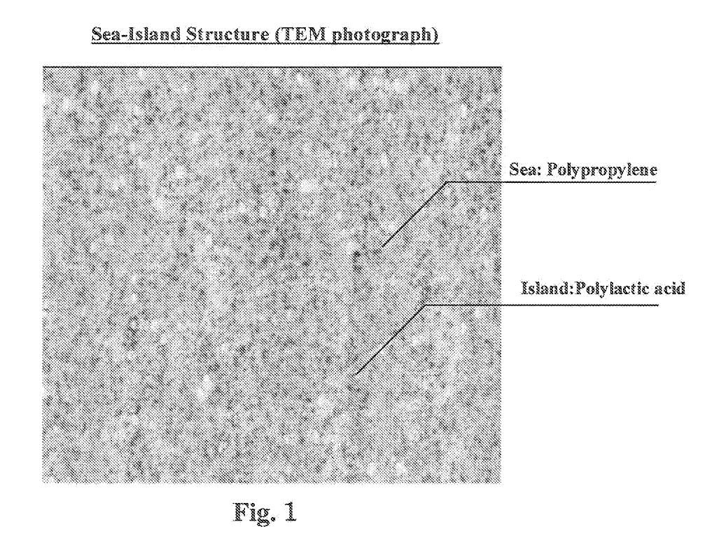

It is important for the polylactic acid resin (A) and the polyolefin resin (B) to be blended uniformly. The term “blended uniformly” refers to a morphology as described below. FIG. 1 shows a photography of a cross section of a sliced specimen of the polymer alloy fiber observed by transmission electron microscopy (TEM) (40,000×), and as seen from this, the materials has a sea-island structure consisting of a continuous matrix, sea component (gray portions) and a nearly round, dispersed island components (white and black portions). The white portions are formed of the polylactic acid resin (A), and the black portions are formed of the compatibilizer (C). The black and white two-layer structure portions are two-layer domains formed of the polylactic acid resin (A) and the compatibilizer (C). Assuming that the domain size of the polylactic acid resin (A) which constitutes the island component in FIG. 1 can be represented by a converted diameter (assuming that each domain is a circle, and its diameter is calculated from the area of the domain), the material is regarded as blended with sufficient uniformity if the converted diameter is preferably as small as 0.005 to 2 μm. The wear resistance of the fiber can be improved dramatically by maintaining the domain size of the island component within the range. The adhesive strength to the polyolefin resin (B) of the sea component improves with a decreasing island domain size as the stress at the interface is deconcentrated, but the initial abrasion properties tends to deteriorate as the domain size decreases below a certain level. Accordingly, the island domain size is more preferably 0.01 to 1.5 μm, and still more preferably 0.02 to 1.0 μm. For control of the gloss of crimps to be formed, it is further preferable to limit the domain diameter to a specific range. If the domain diameter covers the visible wavelength range (0.4 to 0.8 μm) and down to its 1/5 wavelength range (0.08 to 0.16 μm), favorable light scattering will occur within the fiber, leading to good appearance with gentle gloss. To achieve such beautiful gloss, the domain diameter is preferably in the range of 0.08 to 0.8 μm.

As described later in paragraph G under Examples, the size of 100 domains in a stretched yarn specimen is measured, and after eliminating 10 largest and 10 smallest domains, the distribution of the remaining 80 domains is used as the domain size.

For the polymer alloy fiber it is important that the polylactic acid resin (A) and the polyolefin resin (B) are virtually isolated, unlike the case of a block copolymer consisting of polylactic acid blocks and polyolefin blocks connected alternately in one molecular chain. The difference between these states represents the decrease in the melting point of the polyolefin resin caused by the blending, as determined by the difference of the melting point of the polyolefin resin derived component decreased from that of the polyolefin resin before being blended. If the fall in the melting point of the polyolefin resin is 3° C. or less, it indicates that the polylactic acid resin and polyolefin scarcely undergo copolymerization, but instead, the molecular chains of polylactic acid and those of polyolefin are virtually isolated in the polymer alloy. Furthermore, the fiber surface layer is virtually formed only of polyolefin resin, i.e., sea component, and the inherent characteristics of the polyolefin resin are reflected, leading to a dramatic improvement in wear resistance. Thus, the fall in the melting point of the polyolefin is preferably 2° C. or less.

Thus, the polymer alloy fiber is formed of a polymer alloy that consists of the polylactic acid resin (A) and the polyolefin resin (B) to construct a sea-island structure where the polylactic acid resin (A) and the polyolefin resin (B) act as the island and sea components, respectively. In addition, the domain size of the island component is controlled to achieve dramatic improvement in wear resistance and development of high-quality gloss.

Furthermore, one or more catalysts with a relatively large molecular weight, such as metal stearate, may be added so that these catalysts will work to prevent a decrease in the heat resistance of the resin. Their quantity added is preferably 5 to 2,000 ppm, more preferably 10 to 1,000 ppm, and still more preferably 20 to 500 ppm, relative to the synthetic fiber from the viewpoint of controlling the dispersibility and reactivity.

The polymer alloy fiber preferably has a strength of 1 cN/dtex or more, more preferably 1.5 cN/dtex or more, to maintain smooth process passage and to produce products with high mechanical strength. It is still more preferably 2 cN/dtex or more, and particularly preferably 3 cN/dtex or more. A polymer alloy fiber with such a strength can be produced by melt spinning and stretching as described later. If the rupture elongation is 15 to 80%, smooth process passage can be maintained during production of fiber products, and so it is preferable. It is more preferably 20 to 70%, and still more preferably 25 to 60%. It is extremely difficult, however, to produce a polymer alloy fiber with a strength of 7 cN/dtex or more by using a general purpose industrial process that is available at present.

The polymer alloy fiber preferably has a boiling water shrinkage of 0 to 10% so that fiber and fiber products with a high dimensional stability will be produced. It is more preferably 0 to 8%, still more preferably 0 to 6%, and most preferably 0 to 4%.

It is preferable that the polymer alloy fiber is used to provide multifilaments for false twisting or subjected to air jet stuffing to provide long-fibered crimped yarns. Crimped yarns produced from the polymer alloy fiber can develop crimps efficiently, have a high resilience, and also have other features such as lightweight and heat retaining properties. When the crimp elongation rate, for instance, is measured after boiling water processing as an indicator of the crimp characteristics, the crimp elongation rate can be adjusted in the range of 3 to 30%. The measurement of the crimp elongation rate after boiling water processing is carried out as described below.

A crimped yarn unwound from a package (crimped yarn wind-up drum or bobbin) is left to stand in an atmosphere with an environment temperature of 25±5° C. and a relative humidity of 60±10% for 20 hours or more and immersed in boiling water for 30 minutes without applying a load. After the processing, the yarn is left to stand in the same environment as above overnight (about 24 hours) for air-drying to provide a specimen of a boiling water-processed crimped yarn. An initial load of 1.8 mg/dtex is applied to this specimen for 30 seconds, followed by putting a mark at a specimen length of 50 cm (L1). Then, a load of 90 mg/dtex is applied, instead of the initial load, for 30 seconds, followed by measuring the specimen length (L2). Then, the crimp elongation (%) after boiling water processing is calculated by the following equation:

Crimp elongation (%)=[(L2−L1)/L1]×100.

If the crimp elongation of a crimped yarn after boiling water processing is 5% or more, such a yarn can serve to produce good soft material for spring and summer for, for instance, carpets. If the crimp elongation after boiling water processing is maintained below 30%, on the other hand, the yarn will have good dyeing properties during a dyeing process and can serve to produce bulky material with high quality appearance.

The polymer alloy fiber has a high durability, such as strength retention, during cloth structure formation processes, such as dyeing and bulky yarn production, and during long term use after final product production, serving for the final products to maintaining good appearance for a long period of time. The cross section of the polymer alloy fiber may be any of the following: circular, hollow, porous hollow, tri- or multi-foliate, flattened, W-shape, X-shape, and other deformed shapes. To produce a bulky multifilament fiber structure with a high bulkiness from the polymer alloy fiber, its cross-section preferably has a deformation degree (D1/D2) of 1.2 to 7. A yarn with a deformed cross-section can serve to produce a more bulky fiber structure as its deformation degree increases. If the deformation degree is too high, however, the resulting fiber will become high in bending rigidity, leading to problems such as a decrease in flexibility, division of fiber (fibrillation), and excessive gloss. Thus, the deformation degree is preferably in the range of 1.3 to 5.5, more preferably 1.5 to 3.5.

With respect to the morphology of the polymer alloy fiber, it may be a monofilament, formed of only one long fiber, or a multifilament, or the polymer alloy fiber produced may be cut to appropriate length to provide short fibers.

When the polymer alloy fiber is used to produce a fiber structure, the structure may be woven fabric, knitted fabric, nonwoven fabric, pile, or cotton, and it may contain other fibers. The other fibers may be, for instance, natural fiber, reclaimed fiber, semisynthetic fiber, paralleled yarn with synthetic fiber, twisted yarn, and commingled yarn. Specifically, they include natural fiber such as cotton, hemp, wool, and silk; reclaimed fiber such as rayon and cupra; semisynthetic fiber such as acetate fiber; and synthetic fiber such as nylon, polyester (polyethylene terephthalate, polybutylene terephthalate, and the like), polyacrylonitrile, and polyvinyl chloride.

Fiber structures produced from the polymer alloy fiber are used as material for clothing that require wear resistance including, for instance, sportswear such as outdoor wear, golf wear, athletic wear, skiing wear, snow board wear, and pants used in combination with them; casual wear such as blouson; and women's or men's outer clothing such as coat, heavy winter clothes, and rain wear. Examples of products that require long term durability and resistance to humid aging include uniforms, various covers, and other similar materials, and the structures can be used preferably for these uses. They also serve as interior finishing material for automobiles, particularly including carpets for interior finishing of automobiles which require high wear resistance and resistance to humid aging. Furthermore, they are not limited to these uses, and may also be used to produce, for instance, weed control sheets for agriculture or waterproof sheets for construction.

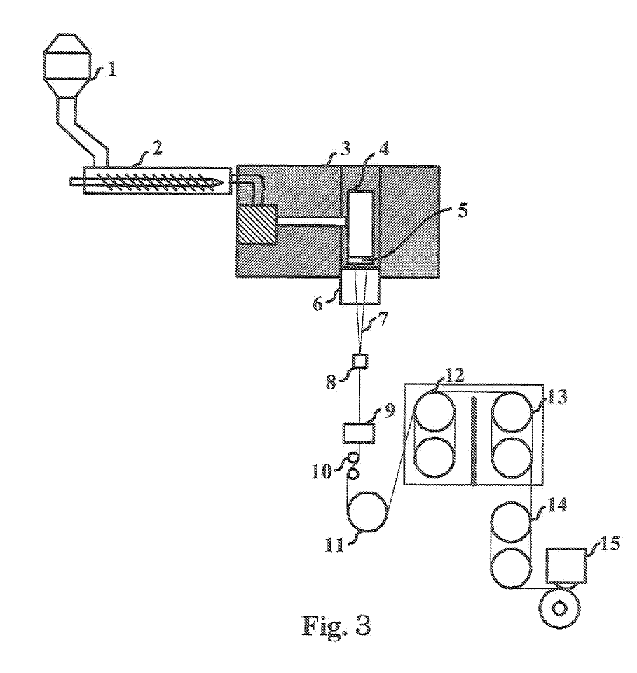

There are no specific limitations on the production method to be used for the polymer alloy fiber, and for instance, a direct spinning/stretching apparatus as shown in FIG. 3 may be used to carrying out the following procedure. When combining the polylactic acid resin (A), the polyolefin resin (B), and the compatibilizer (C), the materials are weighed out and blended so that the polylactic acid resin (A) accounts for preferably 1 to 45 parts by weight, more preferably 10 to 45 parts by weight, still more preferably 15 to 40 parts by weight, and most preferably 20 to 35 parts by weight, relative to 100 parts by weight accounted for by the total quantity of the polylactic acid resin (A) and the polyolefin resin (B), and also that the compatibilizer (C) accounts for preferably 1 to 30 parts by weight, more preferably 3 to 15 parts by weight, and still more preferably 5 to 10 parts by weight. Before doing this, the polylactic acid resin (A), which is highly hygroscopic, should be dried in a vacuum or in a nitrogen atmosphere at 80 to 150° C., and subsequently stored in a moisture barrier container. Before melt spinning, the moisture content of the polylactic acid resin (A) is preferably 0.05% or less, more preferably 0.02% or less, and most preferably 0.008% or less.

It is important that the relative melt viscosities of the polylactic acid resin (A), the polyolefin resin (B), and the compatibilizer (C), and the melt viscosity of the polyolefin resin (B), which forms the sea component, should be maintained in specific ranges. It is preferable that the alloy has a highly uniform phase structure, that the polylactic acid resin (B) is not virtually exposed at the fiber surface, and that the domain size of the island component is 0.01 to 2 μm. To this end, their melt viscosity characteristics are preferably as described below.

When the melt viscosity is measured at a measuring temperature of 230° C. and a shear rate of 6.1 (sec⁻¹), the viscosity ratio (η_{A}/η_{B}) between the melt viscosity η_{A} of the polylactic acid resin (A) and the melt viscosity η_{B} of the polyolefin resin (B) is preferably 1.3 to 10, more preferably 1.8 to 9. It is still more preferably 3 to 8. The polyolefin resin (B) to form the sea component preferably has a melt viscosity η_{B} of 200 Pa·s or less, more preferably 150 Pa·s or less. Furthermore, the melt viscosity η_{C} of the compatibilizer (C) is preferably higher than that of the polyolefin resin (B) which forms the sea component. By meeting the relation of η_{C}>η_{B}, the compatibilizer (C) can act effectively on the interface between the polylactic acid resin (A) and the polyolefin resin (B), allowing a smaller amount of the compatibilizer to work for stabilization of the alloy phase structure. It is more preferable that the melt viscosity of the compatibilizer (C) meets the melt viscosity relation of η_{A}>η_{C}>η_{B}.

Then, the polymers having characteristics and blended at a ratio as mentioned above are kneaded using a uniaxial kneading machine or a biaxial kneading machine, followed by cooling and cutting into chips, or their melts are fed continuously to a spinning apparatus, followed by measuring and melt spinning to produce fiber from the polymer alloy. With respect to the timing of its addition, the compatibilizer (C) may be add at any appropriate point to the kneading process of the polylactic acid resin (A) and the polyolefin resin (B), and the method for its addition may be simply supplying the compatibilizer to the kneading machine for simultaneous kneading with the polylactic acid resin (A) and the polyolefin resin (B), or first preparing master pellets containing the compatibilizer (C) at a high concentration and mixing them with pellets of the polylactic acid resin (A) and the polyolefin resin (B), followed by their supply to the kneading machine. The jacket temperature for the kneading in the melt-extrusion process is preferably Tma+5° C. to Tmb+50° C., where Tma represents the melting point the polylactic acid resin (A), and the shear velocity is preferably 300 to 9,800 sec⁻¹. Maintaining the jacket temperature and shear velocity in these ranges serves to develop a highly uniform alloy phase structure while decreasing the domain size of the island component to a sufficiently low level. A lower jacket temperature is preferable to prevent coloring of the resin, and it is more preferably Tma+5 to 30° C. Similarly, the spinning temperature should preferably as low as possible to prevent the destruction of alloy phase structure as well as the coloring, and it is preferably in the range of Tma+30° C. to Tma+70° C. The spinning temperature is more preferably Tma+30° C. to Tma+50° C.

A fine mesh (#100 to #200) filter layer, porous metal layer, nonwoven fabric filter with a small filtering pore diameter (filtering pore diameter 5 to 30 μm), or in-pack blending mixer (static mixer, Hi-Mixer or the like) may be installed on the orifice to control the domain diameters of the island domains by depressing their reaggregation in the spinning pack. Of these, the use of a multi-layered filter made of metal nonwoven fabrics with different wire diameters is the most effective for controlling the domain diameter. The nonwoven fabrics in the core portion of the multi-layered filter preferably has a thickness of is 0.3 to 3 mm to enhance the blending performance of the multi-layered filter. The filter will be broken more easily by the back pressure on the filter if the filter is too thick, and therefore, the thickness is more preferably 0.4 to 2 mm, and still more preferably 0.5 to 1 mm.

As the polylactic acid resin (A) and the polyolefin resin (B) are incompatible with each other, a high interface tension develops on the interface between them, and accordingly, the melt shows extremely elastic behaviors, leading to the formation of a bulge due to the ballast effect. To reduce the bulge of the yarn caused by the ballast effect and achieve stable elongation and yarn thinning to improve the state of spinning, it is preferable that the following conditions are met: first, the temperature of the orifice surface is 210 to 230° C.; second, the orifice back pressure at the orifice surface temperature is 1 to 5 Mpa; and third, the average polymer flow rate in the orifice discharge hole is 0.03 to 0.30 m/sec.

This orifice surface temperature is intended to enhance the polymer's molecular mobility, thereby to promote the relaxation of the island domains immediately after the discharge. If the above-mentioned conditions are met, the island domains are relaxed quickly so that the polymer's elongational flow will not be impeded significantly. The orifice back pressure is a parameter having a correlation with the quantity of elastic energy stored in the polymer as it moves through the orifice discharge hole. As the orifice back pressure decreases, the quantity of stored elastic energy decreases and the polymer's elongational flow becomes more stable. If the orifice back pressure is less than 1 Mpa, however, the discharge hole loses its measuring functionality and the discharge becomes unstable. Thus, it is more preferably 1 to 4 MPa, and more preferably 1 to 3 Mpa. If the average polymer flow rate in the orifice discharge hole is maintained at 0.03 to 0.3 m/sec, the deformation ratio of the island domains can be decreased, and this serves to promote the relaxation of the island domains immediately after discharge and the stabilization of the elongational deformation from discharge to winding-up, allowing the yarn to be deformed to a high degree (increased draft ratio) over the entire melt spinning process. The average polymer flow rate in the orifice discharge hole is preferably 0.05 to 0.25 m/sec, and more preferably 0.07 to 0.20 m/sec.

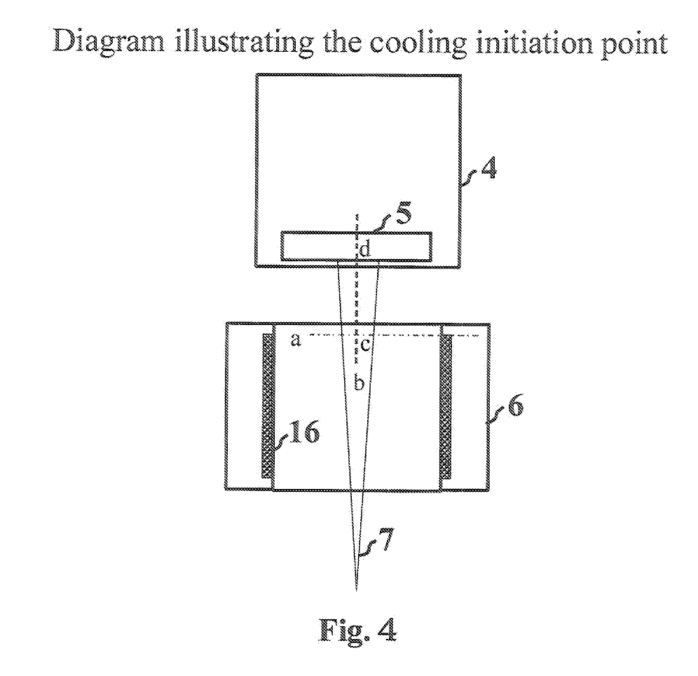

The elongational flow region of the spun fiber should be as close as possible to the orifice surface, and the flow should be as fast as possible (i.e., the distance from discharge to the end of thinning should be minimized). Accordingly, the spun fiber should start to be cooled at a point as close as possible to the orifice surface and, actually, the cooling should preferably start at a point 0.01 to 0.15 m virtually vertically below the orifice surface. “The cooling start point virtually vertically below” means the point c in FIG. 4, which gives an enlargement of the discharge portion, where the line a is drawn horizontally from the top end of the cooling air blower face, and intersects the line b, that is, the vertical line drawn from the orifice surface, at the intersection point c. Thus, the distance from the orifice surface d to the point c along the vertical line b should be 0.01 to 0.15 m. The position of the cooling start point is more preferably 0.01 to 0.12 m virtually vertically below the orifice surface, and still more preferably 0.01 to 0.08 m virtually vertically below the orifice surface.

Examples of this cooling method include the use of a uniflow chimney that performs cooling from one direction or a circular chimney that cools the yarn from inside to outside, of which the use of a circular chimney that cools the yarn from inside to outside is preferable because it can perform cooling uniformly and rapidly. In doing this, it is preferable that the gas for cooling the multifilament is applied from a direction virtually at right angles to the multifilament. “Virtually at right angles” means that the flow line of the cooling gas nearly perpendicular (with an inclination of 70 to 110°) to the line b as shown in FIG. 4. There are no specific limitations on the type of gas to be used for the cooling, but it is preferably a gas that is stable (very low reactivity) at room temperature, such as argon, helium, other rare gases, nitrogen, and air, of which nitrogen and air are particularly preferable because they are available at low prices.

For this step, the speed of the cooling gas flow is preferably 0.3 to 1 m/sec, and more preferably 0.4 to 0.8 m/sec. the temperature of the cooling gas flow is preferably as low as possible to achieve quick cooling of the yarn, but practically, it is preferably 15 to 25° C. taking into consideration the cost required for conditioning of the gas. As described above, the polymer alloy fiber can be spun and taken up stably only when the following requirements are met: specific polymers are combined to form a sea-island structure; the spinning temperature is properly controlled so that the sea-island structure is not damaged as it is discharged; the line speed of the material discharged through orifice discharge hole is properly controlled; and the cooling method and conditions are properly managed. The multifilament thus spun is then coated by applying a generally known spun fiber finishing agent for polypropylene. With respect to the feed quantity of the finishing agent, its net oil content should account for 0.3 to 3 wt % (when the ratio of the oil content to water or low viscosity mineral oil is 10:90, the emulsion should account for 3 to 30 wt % relative to the weight of the yarn).

The yarn is spun at a speed of 300 to 5,000 m/min and then either wound up temporarily or stretched continuously. The polymer alloy fiber, however, easily undergoes orientation relaxation if left in an upstretched state and, accordingly, it easily suffer variations in strength and elongation characteristics and heat shrinkage characteristics if there is a time lag between unstretched packages. Thus, it is preferable to adopt the direct spinning and stretching method that carry out spinning and stretching in one process.

The stretching may be carried out in one, two or three stages. If stretched at a high speed, however, the fiber tends to suffer irregularities in fiber diameter (uneven diameter along the fiber length direction) due to strain-hardening, and therefore, it is preferable that the stretching is carried out in two or more stages. In this case, it is preferable that the first-stage stretching is performed at a stretching temperature of 60 to 110° C. and a draw ratio of 1.5 to 3, and the second-stage stretching is performed at a stretching temperature of 80 to 140° C. and a draw ratio of 1.1 to 3. In an example of two-stage stretching, the yarn is spun, for instance, at a speed of 600 m/min on a first heating roll, followed by a first-stage stretching between the first heating roll and a second heating roll. In this step, the circumferential speed of the second heating roll is set to 1,800 m/min (300% stretching), and the temperature of the first heating roll and that of the second heating roll are adjusted to 50° C. and 110° C., respectively. Then, a second-stage stretching is carried out between the second heating roll and a third heating roll. In this step, the circumferential speed of the third heating roll is set to 3,240 m/min (180% stretching between second and third heating rolls), and heat setting is performed at a third heating roll temperature of 140° C., followed by transporting the yarn on a fourth roll (non-heating roll, circumferential speed of 3,200 m/min) and winding up in a package. The overall draw ratio may be adjusted so that the resulting stretched yarn has an elongation percentage of 15 to 80%. A stretching temperature and draw ratio controlled in the ranges serve to maintain process stability and produce a stretched yarn with a high strength and a low unevenness (Uster test unevenness, U %). A false twisting apparatus or an air jet stuffer apparatus may be used to produce a bulked yarn.

The air jet stuffer apparatus as referred to herein is a crimper machine generally used to produce crimped yarns for BCF carpets, which uses turbulent air flows to cause irregular entangled loops to produce a bulky filament.

### EXAMPLES

Fibers and fiber structures are described in detail below with reference to Examples. The measuring methods used in Examples are as described below.

### A. Weight Average Molecular Weight of the Polylactic Acid Resin (A)

A chloroform solution of a specimen (polylactic acid resin) was mixed with tetrahydrofuran to prepare a test solution. It was analyzed by gel permeation chromatography (GPC) to determine its weight average molecular weight in terms of polystyrene. For determination of the weight average molecular weight of polylactic acid in fiber, a specimen is dissolved in chloroform and filtered to remove polyolefin residue, and then the chloroform solution is evaporated to obtain polylactic acid resin to be tested.

### B. Residual Lactide Content in Polylactic Acid Resin

A 1 g specimen (polylactic acid resin) was dissolved in 20 ml of dichloromethane to prepare a solution, to which 5 ml of acetone was added. It was further diluted to volume with cyclohexane for precipitation, analyzed by liquid chromatography using GC17A supplied by Shimadzu Corporation, and the lactide content was determined by the absolute calibration curve method. For polylactic acid contained in fiber, the blend ratio relation between polylactic acid and polyolefin was determined in advance from TEM observation as described later, and the lactide content was calculated based correction using the blend ratio.

### C. Carboxyl End Concentration

A precisely weighed specimen (polylactic acid resin extracted by the following method) was dissolved in o-cresol (5% moisture), and an appropriate quantity of dichloromethane was added to the resulting solution, followed by titration with a 0.02N KOH methanol solution for determination. In this operation, oligomers such as lactide and other cyclic dimers of lactic acid are hydrolyzed to form carboxyl ends, and therefore, the carboxyl end concentration was measured for the total including the carboxyl ends in the polymer, monomer-derived carboxyl ends, and oligomer-derived carboxyl ends. There are no particular limitations on the method for extraction of polylactic acid resin from polymer alloy fiber, but for the Examples, polylactic acid resin was dissolved in chloroform, filtered to remove polyolefin, extracted by evaporating the filtrate.

### D. Melting Point of Polymer and Heat of Crystal Melting

A 20 mg specimen was analyzed with a Perkin-Elmer DSC-7 differential scanning calorimeter at a heating rate of 10° C./min to prepare a melting endothermic curve, and the temperature at the peak was taken as melting point (° C.). In addition, the heat of crystal melting, ΔH (J/g), of the polymer was determined from the area (crystal melting peak area) defined by the peak and baseline.

### E. Melt Viscosity η

The melt viscosity of the polylactic acid resin (A), the polyolefin resin (B) and the compatibilizer (C) was measured using Capilograph 1B supplied by Toyo Seiki Co., Ltd. in a nitrogen atmosphere at a temperature of 230° C. and a shear velocity of 6.1 (sec⁻¹). Three measurements were taken and their average was used for melt viscosity evaluation.

### F. Domain Size and Blend Ratio of Island Component in Polymer Alloy Fiber

An ultrathin section was cut out of the polymer alloy fiber in a direction vertical to the fiber axis (cross-sectional direction of fiber), and the blending state in the section was observed and photographed by transmission electron microscopy (TEM) at a magnification of 40,000. The photograph taken was analyzed with a WinROOF image analysis program supplied by Mitani Corporation to determine the size of the undyed portions as island domain diameter. Each domain is assumed to be a circle, and its diameter (converted diameter, 2r) is calculated from the area of the domain. For each specimen, 100 domains were observed, and 10 largest and 10 smallest domains were excluded, followed by determining the diameter distribution for the remaining 80 domains

To provide the blend ratio between the polylactic acid resin (A) and the polyolefin resin (B) in the fiber, the ratio between their cross sections was measured from the TEM photograph taken above (5.93×4.65 μm) and corrected based on the specific gravity of each component to calculate their weight ratio. For Examples described below, the specific gravity of each component was assumed as follows: 1.24 for polylactic acid and 0.91 for polyolefin.
TEM apparatus: H-7100FA supplied by Hitachi, Ltd.
Conditions: an accelerating voltage of 100 kV

### G. Observation of Morphology of Fiber Surface (Side Face)

Polymer alloy fiber was immersed (alkali etching) overnight in a 20 wt % solution of sodium hydroxide and the state of the fiber surface was observed and photographed at a magnification of 5,000 by a ESEM-2700 electron microscope supplied by Nikon Instech Co., Ltd. The photograph taken was analyzed with a WinROOF image analysis program supplied by Mitani Corporation to determine the area occupied by streak-like grooves found in a 10 μm×10 μm field of view on the surface of the fiber. For each specimen, three portions were observed, and the average percent area (%) of the streak-like grooves.

Percent area of streak-like grooves (%)=(area of streak-like grooves)/(surface area of fiber)×100

### H. Fineness

A yarn of 100 m was taken on a sizing reel and the weight of the 100 m yarn was measured and multiplied by 100 to calculate its fineness (dtex). Three measurements were made and their average was taken for fineness (dtex) evaluation.

### I. Strength and Rupture Elongation

A yarn specimen was analyzed by a UCT-100 Tensilon tester supplied by Orientec Co., Ltd. under constant rate extension conditions according to JIS L1013 (chemical fiber filament test method, 1998). The grip interval (specimen length) was set to 200 mm. The rupture elongation was determined from the elongation at the point of maximum strength in the S-S curve.

### J. Boiling Water Shrinkage

A yarn specimen was immersed in boiling water for 15 minutes, and the difference in size between before and after the immersion was measured, followed by calculation by the following equation:

Boiling water shrinkage (%)=[(L₀−L₁)/L₀]×100
L₀: hank length of a specimen wound into a hank and subjected to measurement at an initial load of 0.088 cN/dtex
L₁: hank length of the hank used for L₀ measurement treated in boiling water without load and air-dried, followed by measurement at an initial load of 0.088 cN/dtex.

### K. Unevenness of Yarn, U %

The half-inert value (U %) of a yarn specimen was measured with UT4-CX/M supplied by Zellweger Uster under the conditions of a yarn speed of 200 m/min and a measuring time of 1 minute.

### L. Crimp Elongation

A crimped yarn unwound from a package (drum or bobbin with wound-up crimped yarn) left to stand in an atmosphere with an environment temperature of 25±5° C. and a relative humidity of 60±10% for 20 hours or more was immersed in boiling water for 30 minutes without applying a load. Following the immersion treatment the yarn was air-dried in the above mentioned environment overnight (roughly 24 hours) to provide a specimen of a crimped yarn treated in boiling water. An initial load of 1.8 mg/dtex was applied to this specimen for 30 seconds and a mark was put at a specimen length of 50 cm (L1). Subsequently, the initial load was replaced with a test load of 90 mg/dtex, and the specimen length (L2) was measured after 30 seconds. The crimp elongation (%) of a boiling water treated specimen was calculated by the following equation:

Crimp elongation (%)=[(L2−L1)/L1]×100.

### M. Wear Resistance

P600 sandpaper was put around the roller of a twine abrasion testing machine supplied by Ando Iron Works, Ltd. and the roller was rotated under the following conditions to measure the number of rotations before breakage of the yarn:
Diameter of rotating body: 40 mm
Contact length of yarn: 110 mm
Speed of rotation: 200 rpm
Test load: 0.4 cN/dtex.
   N. Average Particle Diameter of D50 of Crystal Nucleating Agent, and Content of Particles with Diameter of 10 μm or More in Crystal Nucleating Agent

SALD-2000J supplied by Shimadzu Corporation was used to measure the average particle diameter D50 (μm) of the crystal nucleating agent by the laser diffraction method. The content (vol %) of particles with a diameter of 10 μm or more in the crystal nucleating agent was determined from the resulting particle size distribution.

### O. Wear Resistance (Percent Abrasion Loss) of Carpet

Crimped yarns were S- or Z-twisted, and two yarns were twisted together. The resulting yarn was used as face yarn to tuft a PP spunbonded nonwoven fabric, followed by coating the rear side of the base fabric and drying it to prepare a tufted carpet (with a Metsuke (weight per unit surface area) of 1,200 g/m²). A circular portion with a diameter of 120 mm was cut out of the tufted carpet and a 6 mm hole was made at the center to provide a test piece. The weight of the test piece, W₀, was measured, and then fixed with its front face upward in a Taber abrader (Rotary Abaster) as specified in ASTM D 1175 (1994), followed by performing wear resistance test under the conditions of the use of a H-18 abrasion ring, a compression load of 1 kgf (9.8N), a specimen holder rotating speed of 70 rpm, and the number of abrasion cycles of 5,500 to determine the weight of the test piece after wear resistance test, W₂. The percent abrasion loss was calculated from these measurements by the following equation:

Percent abrasion loss (%)=(W₀−W₁)×100/(W₂×A₁/A₀)
W₀: weight (g) of circular carpet test piece before test
W₁: weight (g) of circular carpet test piece after test
W₂: Metsuke (weight per unit surface area) (g/m²) of carpet
A₀: total area (m²) of circular carpet test piece
A₁: total area (m²) of portion in contact with abrasion ring.

### P. Tactility (Flexibility) and Appearance (Glossiness) of Carpet

Tactility (flexibility) of the carpet was assessed by pressing the test piece with the palm. Glossiness and uneven gloss were observed visually in sunshine. Tactility and appearance was evaluated according to the following four grade criterion:
⊚: very good
◯: good
Δ: equivalent to conventional products
X: inferior to conventional products.

### Production Example 1

### Production of Polylactic Acid

Lactide produced from L-lactic acid with an optical purity of 99.8% was polymerized using a bis(2-ethylhexanoate)tin catalyst (lactide vs. catalyst molar ratio=10,000:1) in an nitrogen atmosphere 180° C. for 240 minutes to prepare polylactic acid P1. The resulting polylactic acid had a weight average molecular weight of 233,000. The residual lactide accounted for 0.12 wt %.

### Production Example 2

### Production of Polylactic Acid

Lactide produced from L-lactic acid with an optical purity of 99.8% was polymerized using a bis(2-ethylhexanoate)tin catalyst (lactide vs. catalyst molar ratio=10,000:1) in an nitrogen atmosphere 180° C. for 150 minutes to prepare polylactic acid P2. The resulting polylactic acid had a weight average molecular weight of 150,000. The residual lactide accounted for 0.10 wt %.

### [Polyolefin]

(O1) S119 supplied by Prime Polymer Co., Ltd. (MFR 60 [at temperature of 230° C.], melting point 166° C., heat of crystal melting 110 J/g, melt viscosity 128 Pa·s)
(O2) ZS1337A supplied by Prime Polymer Co., Ltd. (MFR 26 [at temperature of 230° C.], melting point 165° C., heat of crystal melting 107 J/g, melt viscosity 195 Pa·s)
(O3) S115 supplied by Prime Polymer Co., Ltd. (MFR 12 [at temperature of 230° C.], melting point 165° C., heat of crystal melting 102 J/g, melt viscosity 295 Pa·s)

### [Compatibilizer]

(C1) amino modified SEBS, Dynalon 8630P supplied by supplied by JSR Corporation (styrene content 15 wt %, MFR 15 g/10 min (230° C., 21.2N))
(C2) imine modified SEBS, Tuftec N503 supplied by Asahi Kasei Chemicals Corporation (styrene content 30 wt %, MFR 20 g/10 min (230° C., 21.2N))
(C3) maleic anhydride modified SEBS, Clayton FG1924 supplied by Clayton (styrene content 13 wt %, maleic anhydride content 1 wt %, MFR 11 g/10 min (230° C., 21.2N))

### Example 1

A chip blend of polylactic acid P1 (melting point 177° C., melt viscosity 770 Pa·s) used the polylactic acid resin (A), O1 used as the polyolefin resin (B), and C1 (melt viscosity 555 Pa·s) used as the compatibilizer, which accounted for 30 parts by weight, 70 parts by weight, 5 parts by weight respectively (totaling 105 parts by weight) was fed to the hopper 1 of a spinning apparatus equipped with a biaxial kneading machine (unidirectional biaxial, axis diameter 20 mm, L/D 45) as shown in FIG. 3. The polylactic acid resin (A) was dried for about 5 hours in a vacuum at 110° C. for moisture conditioning to adjust its moisture content to 80 ppm. The blend was kneaded in the twin-screw extruder kneader 2 at a jacket temperature of 200° C. and an axial rotation speed of 300 rpm during kneading. While kneading is continued, the molten polymer blend was fed to the spinning block 3 held at a temperature of 230° C., measured and pushed forward by a gear pump into the built-in spinning pack 4 and spun through the spinning orifice 5. The spinning pack had a SUS nonwoven fabric filter (nonwoven fabric with a thickness of 0.6 mm) with an absolute filtration diameter of 10 μm installed directly above the orifice. The orifice used had a round hole with a diameter of 0.9 mm and a hole depth of 6.3 mm. The orifice surface temperature was 223° C. The cyclic chimney 6 (cooling length 30 cm) was installed so that the upper end of the blowout hole came at a position 5 cm below the orifice surface, and the yarn 7 was cooled and solidified at a cooling air temperature of 20° C. and a cooling air speed of 0.5 m/sec. Oil was supplied in two stages by the oil feeder 8 and the oil feeder 9. A mixture of polyether oil and low viscosity mineral oil mixed at a ratio of 15:85 was used as the spinning oil and applied to the yarn at a deposition rate of 10% relative to the yarn (net oil content 1.5% owf).

Subsequently, the yarn was taken off at a spinning speed of 700 m/min by the first heating roll 11 (hereinafter referred to as 1FR) adjusted to a temperature of 60° C. Then, the first step stretching (draw ratio 2.8) was carried out at 1,960 m/min by the second heating roll 12 (hereinafter referred to as 1DR) adjusted to a temperature of 110° C., and the second step stretching (draw ratio 1.79) was carried out at 3,500 m/min by the third heating roll 13 (hereinafter referred to as 2DR) adjusted to a temperature of 140° C. Then, the yarn was cooled on the fourth roll 14 (hereinafter referred to as 3DR) rotating at a circumferential speed of 3,500 m/min, and wound up at a wind-up tension of 22 g (0.1 cN/dtex) and a wind-up speed of 3,448 m/min (relaxation rate 1.5%). Thus, a 225-decitex, 15-filament multifilament of polymer alloy fiber was obtained. The orifice back pressure was 2.4 MPa, and the average polymer flow rate in the orifice discharge hole was 0.16 m/sec under the following conditions. A total of 2,000,000 meters of multifilaments were produced, and results showed that the spinning and stretching processes were very stable without suffering yarn breakage or monofilament breakage.

TEM observation of a cross section of the resulting fiber showed a uniformly dispersed sea-island structure, and the island domain size was 0.03 to 0.2 μm in terms of converted diameter. A cross-sectional specimen of the yarn was alkali-etched to dissolve and remove polylactic acid. Its observation showed that the island component was missing, confirming that the island component was formed of polylactic acid. The streak-like grooves in the fiber surface accounted for about 3.8%, and the resulting fiber had a strength of 3.1 cN/dtex, rupture elongation of 50%, boiling water shrinkage of 5.8%, and yarn unevenness (U %) of 1.0%, proving good fiber physical properties. In the wear resistance test, 120 rotations were required for breakage of the yarn, showing high wear resistance.

### Example 2

Except that the polylactic acid resin (A) and the polyolefin resin (B) accounted for 10 parts by weight and 90 parts by weight, respectively, the same procedure as in Example 1 was carried out to produce a multifilament. The yarn-making performance in Example 2 was very stable as in Example 1. TEM observation of a cross section of the resulting fiber showed a uniformly dispersed sea-island structure, and the island domain size was 0.01 to 0.15 μm in term of converted diameter, indicating that the island component had a smaller dispersion diameter than in Example 1. A cross-sectional specimen of the yarn was alkali-etched to dissolve and remove polylactic acid. Its observation showed that the island component was missing, confirming that the island component was formed of polylactic acid. The resulting fiber had good fiber properties and high wear resistance.

### Example 3

Except that the polylactic acid resin (A) and the polyolefin resin (B) accounted for 40 parts by weight and 60 parts by weight, respectively, the same procedure as in Example 1 was carried out to produce a multifilament. The yarn-making performance in Example 3 was very stable as in Example 1. TEM observation of a cross section of the resulting fiber showed a uniformly dispersed sea-island structure, and the island domain size was 0.03 to 0.6 μm in term of converted diameter, indicating that the island component had a larger dispersion diameter than in Example 1. In the alkali-etched specimen, the streak-like grooves accounted for about 5.5% of the surface area, indicating that the streak-like grooves caused a decrease in wear resistance, though the yarn had practical durability.

### Example 4

Except that the polylactic acid resin (A) and the polyolefin resin (B) accounted for 5 parts by weight and 95 parts by weight, respectively, the same procedure as in Example 1 was carried out to produce a multifilament. The yarn-making performance in Example 4 was very stable as in Example 1. TEM observation of a cross section of the resulting fiber showed a uniformly dispersed sea-island structure, and the island domain size was 0.01 to 0.1 μm in term of converted diameter, indicating that the island component had an extremely small dispersion diameter and that the number of islands was also small. Streak-like grooves were not found in the fiber surface of the multifilament.

### Example 5

Except that the polylactic acid resin (A) and the polyolefin resin (B) accounted for 47 parts by weight and 53 parts by weight, respectively, the same procedure as in Example 1 was carried out to produce a multifilament. In Example 5, a total of 200,000 meters of yarns were spun, and yarn breakage took place eight times during this test. TEM observation of a cross section of the resulting fiber showed unevenly dispersed sea-island structure, and the island domain size was 0.1 to 2.8 μm in term of converted diameter, indicating that the dispersion diameter had an extremely broad distribution. The streak-like grooves accounted for 17.3% of the fiber surface. Some streak-like grooves were much larger than those in Example 1. In the wear resistance test, only 37 rotations were required for yarn breakage, limiting the uses, though practical properties were maintained.

### Comparative Example 1

Except that the compatibilizer (C) was not added, the same procedure as in Example 1 was carried out to spin a yarn. Bulging took place immediately below the orifice due to the ballast effect. Furthermore, the elongational deformation along the spin-line was unstable, and spinning cannot be performed at a spinning speed 700 m/min.

### Comparative Example 2

Except that the polylactic acid resin (A) and the polyolefin resin (B) accounted for 70 parts by weight and 30 parts by weight, respectively, and that spinning was performed with a first heating roll temperature of 80° C. and a spinning speed of 850 m/min (first-step draw ratio 2.3), the same procedure as in Example 1 was carried out to produce a multifilament. In Comparative Example 2, a total of 200,000 meters of yarns were produced and yarn breakage took place five times. TEM observation of a cross section of the resulting fiber showed a relatively uneven but well dispersed sea-island structure. A cross-sectional specimen of the yarn was alkali-etched to dissolve and remove polylactic acid. Its observation showed that the sea component was missing, confirming that the island component was formed of polypropylene. In the wear resistance test for the resulting fiber, only 18 rotations were required for yarn breakage, indicating that the yarn would not serve for uses where wear resistance is required.

### Comparative Example 3

Except that only the polylactic acid resin (A) (polylactic acid P1) was used, the same procedure as in Comparative Example 2 was carried out to produce a multifilament. The yarn-making performance in Comparative Example 3 was stable as in Example 1. In the wear resistance test for the resulting multifilament, as small as 8 rotations were required for yarn breakage, indicating that the multifilament would not serve for uses where wear resistance is required.

TABLE 1

| | Example 1 | Example 2 | Example 3 | Example 4 | Example 5 |
|---|---|---|---|---|---|
| polylactic acid resin (A) | P1 | P1 | P1 | P1 | P1 |
| weight average molecular weight | 233,000 | 233,000 | 233,000 | 233,000 | 233,000 |
| melting point (° C.) | 177 | 177 | 177 | 177 | 177 |
| remain lactide quantity (wt %) | 0.12 | 0.12 | 0.12 | 0.12 | 0.12 |
| melt viscosity (Pa · s) | 770 | 770 | 770 | 770 | 770 |
| polyolefin resin (B) | O1 | O1 | O1 | O1 | O1 |
| melting point (° C.) | 166 | 166 | 166 | 166 | 166 |
| heat of crystal melting ΔH(J/g) | 110 | 110 | 110 | 110 | 110 |
| melt viscosity (Pa · s) | 128 | 128 | 128 | 128 | 128 |
| blend ratio (component A/component B, | 30/70 | 10/90 | 40/60 | 5/95 | 47/53 |
| parts by weight) | | | | | |
| melt viscosity ratio (η_{A}/η_{B}) | 6.02 | 6.02 | 6.02 | 6.02 | 6.02 |
| compatibilizer (C) | C1 | C1 | C1 | C1 | C1 |
| melt viscosity (Pa · s) | 555 | 555 | 555 | 555 | 555 |
| content (parts by weight) | 5 | 5 | 5 | 5 | 5 |
| orifice back pressure (MPa) | 2.4 | 2.1 | 2.6 | 2.0 | 3.6 |
| average polymer flow rate in | 0.16 | 0.17 | 0.15 | 0.17 | 0.15 |
| discharge hole (m/sec) | | | | | |
| fiber properties | | | | | |
| island component | PLLA | PLLA | PLLA | PLLA | PLLA |
| sea component | PP | PP | PP | PP | PP |
| domain size of island component (μm) | 0.03~0.2 | 0.01~0.15 | 0.03~0.6 | 0.01~0.1 | 0.1~2.8 |
| area of streak-like grooves in | 3.8 | 1.1 | 5.5 | — | 17.3 |
| fiber surface (%) | | | | | |
| carboxyl end concentration (eq/ton) | 17 | 20 | 16 | 21 | 15 |
| fineness (dtex) | 225 | 225 | 225 | 225 | 225 |
| strength (cN/dtex) | 3.1 | 3.2 | 2.8 | 3.3 | 2.2 |
| rupture elongation (%) | 50 | 56 | 42 | 59 | 40 |
| U % (%) | 1.0 | 0.8 | 1.5 | 0.7 | 2.8 |
| boiling water shrinkage (%) | 5.8 | 4.4 | 6.3 | 3.7 | 6.5 |
| wear resistance (number of times of | 120 | 202 | 91 | 219 | 37 |
| yarn breakage) | | | | | |

| | Comparative | Comparative | Comparative |
|---|---|---|---|
| | Example 1 | Example 2 | Example 3 |
| polylactic acid resin (A) | P1 | P1 | P1 |
| weight average molecular weight | 233,000 | 233,000 | 233,000 |
| melting point (° C.) | 177 | 177 | 177 |
| remain lactide quantity (wt %) | 0.12 | 0.12 | 0.12 |
| melt viscosity (Pa · s) | 770 | 770 | 770 |
| polyolefin resin (B) | O1 | O1 | — |
| melting point (° C.) | 166 | 166 | — |
| heat of crystal melting ΔH(J/g) | 110 | 110 | — |
| melt viscosity (Pa · s) | 128 | 128 | — |
| blend ratio (component A/component B, | 30/70 | 70/30 | 100/0 |
| parts by weight) | | | |
| melt viscosity ratio (η_{A}/η_{B}) | 6.02 | 6.02 | — |
| compatibilizer (C) | — | C1 | — |
| melt viscosity (Pa · s) | — | 555 | — |
| content (parts by weight) | — | 5 | — |
| orifice back pressure (MPa) | 2.2 | 7.9 | 10.2 |
| average polymer flow rate in | 0.16 | 0.14 | 0.13 |
| discharge hole (m/sec) | | | |
| fiber properties | | | |
| island component | — | PP | — |
| sea component | — | PLLA | — |
| domain size of island component (μm) | — | — | — |
| area of streak-like grooves in | — | — | — |
| fiber surface (%) | | | |
| carboxyl end concentration (eq/ton) | — | 13 | 17 |
| fineness (dtex) | — | 225 | 225 |
| strength (cN/dtex) | — | 1.4 | 3.0 |
| rupture elongation (%) | — | 37 | 50 |
| U % (%) | — | 1.8 | 0.7 |
| boiling water shrinkage (%) | — | 7.3 | 8.8 |
| wear resistance (number of times of | — | 18 | 8 |
| yarn breakage) | | | |

### Example 6

Except that O₂ was used as the polyolefin resin (B), the same procedure as in Example 1 was carried out to spin a yarn. Bulging took place immediately below the orifice due to the ballast effect. In Example 6, a total of 200,000 meters of multifilaments were produced, and yarn breakage took place four times during the test. TEM observation of a cross section of the resulting fiber showed that the island domain size was 0.05 to 0.6 μm in terms of converted diameter, which was larger than that in Example 1 and that the yarn unevenness (U %) was also a slightly high 2.1%, though the yarn still had practical properties.

### Example 7

Except that O3 was used as the polyolefin resin (B), the same procedure as in Example 1 was carried out to spin a yarn. Bulging took place immediately below the orifice due to the ballast effect, and the elongational deformation along the spin-line was unstable, resulting in fluctuation in diameter. In Example 6, a total of 200,000 meters of multifilaments were produced, and yarn breakage took place 15 times during the test. TEM observation of a cross section of the resulting fiber showed that the island domain size was 0.1 to 1.1 μm in terms of converted diameter, which was larger than that in Example 6, and that the yarn unevenness (U %) was an extremely high 3.7%. The yarn had practical properties though its uses would be limited.

### Example 8

Except that polylactic acid P2 (melting point 177° C., melt viscosity 240 Pa·s) was used as the polylactic acid resin (A), the same procedure as in Example 1 was carried out to produce a multifilament. The yarn-making performance in Example 7 was relatively stable, and yarn breakage took place twice during spinning of yarns of a total of 200,000 meters. TEM observation of a cross section of the resulting fiber showed a sea-island structure with a slightly low uniformity, with an island domain size of 0.07 to 0.9 μm in terms of converted diameter. In the wear resistance test for the resulting multifilament, 82 rotations were required for yarn breakage, indicating that the yarn had practical durability, though inferior to the yarn in Example 1.

### Example 9

Except that polylactic acid P2 and O3 were used as the polylactic acid resin (A) and the polyolefin resin (B), respectively, the same procedure as in Example 1 was carried out to spin a yarn. Yarn breakage took place 20 times during spinning of yarns of a total of 200,000 meters. TEM observation of a cross section of the resulting fiber showed that the island domain size was 0.1 to 2.2 μm in terms of converted diameter, which was larger than in Example 7. In the wear resistance test, 48 rotations were required for yarn breakage. Thus the yarn had practical properties, though its uses would be limited.

### Examples 10 to 12

Except that the compatibilizer (C1) accounted for 0.5 parts by weight, 15 parts by weight, or 30 parts by weight, the same procedure as in Example 1 was carried out to spin a yarn. In Example 10 where 0.5 parts by weight of the compatibilizer was added, heavy bulging took place immediately below the orifice during spinning, and the elongational deformation along the spin-line was unstable, resulting in fluctuation in diameter. As a result, the yarn unevenness (U %) was a very high 4.1%. In the wear resistance test, 42 rotations were required for yarn breakage, indicating that the yarn had practical properties, though its uses would be limited. In Example 11 where 15 parts by weight of the compatibilizer was added, the strength was slight lower than in Example 1, but the yarn was nearly equivalent in other characteristics to the one in Example 1, indicating its high practicality. In Example 12 where 30 parts by weight of the compatibilizer was added, the yarn had a smaller fiber rigidity than in Example 12, but it was more flexible than in Example 1. Though inferior in wear resistance to the yarn in Example 1, it had an adequately high practical durability.

TABLE 2

| | Example 6 | Example 7 | Example 8 | Example 9 | Example 10 | Example 11 | Example 12 |
|---|---|---|---|---|---|---|---|
| polylactic acid resin (A) | P1 | P1 | P2 | P2 | P1 | P1 | P1 |
| weight average molecular weight | 233,000 | 233,000 | 15.075 | 15.075 | 233,000 | 233,000 | 233,000 |
| melting point (° C.) | 177 | 177 | 177 | 177 | 177 | 177 | 177 |
| remain lactide quantity (wt %) | 0.12 | 0.12 | 0.10 | 0.10 | 0.12 | 0.12 | 0.12 |
| melt viscosity (Pa · s) | 770 | 770 | 240 | 240 | 770 | 770 | 770 |
| polyolefin resin (B) | O2 | O3 | O1 | O3 | O1 | O1 | O1 |
| melting point (° C.) | 165 | 165 | 166 | 165 | 166 | 166 | 166 |
| heat of crystal melting ΔH(J/g) | 107 | 102 | 110 | 102 | 110 | 110 | 110 |
| melt viscosity (Pa · s) | 195 | 295 | 128 | 295 | 128 | 128 | 128 |
| blend ratio (component A/component B, | 30/70 | 30/70 | 30/70 | 30/70 | 30/70 | 30/70 | 30/70 |
| parts by weight) | | | | | | | |
| melt viscosity ratio (η_{A}/η_{B}) | 3.95 | 2.61 | 1.88 | 0.81 | 6.02 | 6.02 | 6.02 |
| compatibilizer (C) | C1 | C1 | C1 | C1 | C1 | C1 | C1 |
| melt viscosity (Pa · s) | 555 | 555 | 555 | 555 | 555 | 555 | 555 |
| content (parts by weight) | 5 | 5 | 5 | 5 | 0.5 | 15 | 30 |
| orifice back pressure (MPa) | 4.4 | 9.3 | 1.7 | 8.6 | 2.2 | 2.8 | 3.3 |
| average polymer flow rate in | 0.16 | 0.16 | 0.16 | 0.16 | 0.16 | 0.16 | 0.16 |
| discharge hole (m/sec) | | | | | | | |
| fiber properties | | | | | | | |
| island component | PLLA | PLLA | PLLA | PLLA | PLLA | PLLA | PLLA |
| sea component | PP | PP | PP | PP | PP | PP | PP |
| domain size of island component (μm) | 0.05~0.6 | 0.1~1.1 | 0.07~0.9 | 0.1~2.2 | 0.1~2.6 | 0.02~0.2 | 0.03~0.3 |
| area of streak-like grooves in | 6.6 | 10.3 | 7.8 | 12.5 | 10.5 | 3.9 | 4.2 |
| fiber surface (%) | | | | | | | |
| carboxyl end concentration (eq/ton) | 17 | 17 | 17 | 17 | 17 | 17 | 17 |
| fineness (dtex) | 225 | 225 | 225 | 225 | 225 | 225 | 225 |
| strength (cN/dtex) | 2.3 | 1.9 | 3.0 | 1.8 | 2.0 | 2.8 | 2.2 |
| rupture elongation (%) | 50 | 52 | 47 | 43 | 50 | 55 | 62 |
| U % (%) | 2.1 | 3.7 | 2.0 | 3.7 | 4.1 | 1.2 | 1.8 |
| boiling water shrinkage (%) | 6.0 | 7.7 | 6.1 | 6.6 | 6.6 | 6.5 | 9.5 |
| wear resistance (number of times of | 73 | 64 | 82 | 48 | 42 | 117 | 92 |
| yarn breakage) | | | | | | | |

### Example 13

Except that C2 was used as the compatibilizer (C) and accounted for 10 parts by weight, the same procedure as in Example 1 was carried out to spin a yarn. In Example 13, slightly large bulging took place immediately below the orifice during spinning, but the spinning proceeded relatively stably, and yarn breakage took place twice during spinning of yarns of a total of 200,000 meters. TEM observation of a cross section of the resulting fiber showed that the island domain size was 0.03 to 0.5 μm in terms of converted diameter, which was slightly larger than in Example 1. In the wear resistance test, 88 rotations were required for yarn breakage, indicating that it had practically high wear resistance.

### Example 14

Except that C3 was used as the compatibilizer (C), the same procedure as in Example 13 was carried out to spin a yarn. In Example 14, larger bulging than in Example 13 took place immediately below the orifice during spinning, and yarn breakage took place 9 times during spinning of yarns of a total of 200,000 meters. TEM observation of a cross section of the resulting fiber showed that the island domain size was 0.05 to 0.8 μm in terms of converted diameter, which was still larger than in Example 13. In the wear resistance test, 72 rotations were required for yarn breakage, indicating that the yarn had practical wear resistance, though its uses would be limited.

### Example 15

Except that an orifice with a diameter of 0.9 mm and a hole depth of 13.5 mm was used, the same procedure as in Example 1 was carried out to spin a yarn. During the spinning in Example 15, the orifice back pressure was 5.2 MPa, and the average flow polymer rate in the orifice discharge hole was 0.16 m/sec. Large bulging took place immediately below the orifice during the spinning Yarn breakage took place as frequently as 21 times during spinning of yarns of a total of 200,000 meters. In the wear resistance test, 76 rotations were required for yarn breakage, indicating that the yarn had practical wear resistance, though its uses would be limited.

### Example 16

Except that an orifice with a diameter of 0.7 mm and a hole depth of 1.4 mm was used, the same procedure as in Example 1 was carried out to spin a yarn. During the spinning in Example 16, the orifice back pressure was 1.0 MPa, and the average flow polymer rate in the orifice discharge hole was 0.26 m/sec. In Example 16, though larger bulging than in Example 1 took place immediately below the orifice during the spinning, the spinning proceeded relatively stably, and yarn breakage took place 3 times during spinning of yarns of a total of 200,000 meters. In the wear resistance test, 103 rotations were required for yarn breakage, indicating that the yarn had practically high wear resistance.

### Example 17

Except that an orifice with a diameter of 2.0 mm and a hole depth of 14 mm was used, the same procedure as in Example 1 was carried out to spin a yarn. During the spinning in Example 17, the orifice back pressure was 1.0 MPa, and the average flow polymer rate in the orifice discharge hole was 0.03 m/sec. In Example 17, though bulging did not take place during the spinning, yarn breakage took place five times during spinning of yarns of a total of 200,000 meters, indicating a slightly inferior stability. In the wear resistance test, 95 rotations were required for yarn breakage, indicating that the yarn had practically high wear resistance.

TABLE 3

| | Example 13 | Example 14 | Example 15 | Example 16 | Example 17 |
|---|---|---|---|---|---|
| polylactic acid resin (A) | P1 | P1 | P1 | P1 | P1 |
| weight average molecular weight | 233,000 | 233,000 | 233,000 | 233,000 | 233,000 |
| melting point (° C.) | 177 | 177 | 177 | 177 | 177 |
| remain lactide quantity (wt %) | 0.12 | 0.12 | 0.12 | 0.12 | 0.12 |
| melt viscosity (Pa · s) | 770 | 770 | 770 | 770 | 770 |
| polyolefin resin (B) | O1 | O1 | O1 | O1 | O1 |
| melting point (° C.) | 166 | 166 | 166 | 166 | 166 |
| heat of crystal melting ΔH(J/g) | 110 | 110 | 110 | 110 | 110 |
| melt viscosity (Pa · s) | 128 | 128 | 128 | 128 | 128 |
| blend ratio (component A/component B, parts by weight) | 30/70 | 30/70 | 30/70 | 30/70 | 30/70 |
| melt viscosity ratio (η_{A}/η_{B}) | 6.02 | 6.02 | 6.02 | 6.02 | 6.02 |
| compatibilizer (C) | C2 | C3 | C1 | C1 | C1 |
| melt viscosity (Pa · s) | 430 | 650 | 555 | 555 | 555 |
| content (parts by weight) | 10 | 10 | 5 | 5 | 5 |
| orifice back pressure (MPa) | 2.5 | 2.7 | 5.2 | 1.0 | 1.0 |
| average polymer flow rate in discharge hole (m/sec) | 0.16 | 0.16 | 0.16 | 0.26 | 0.03 |
| fiber properties | | | | | |
| island component | PLLA | PLLA | PLLA | PLLA | PLLA |
| sea component | PP | PP | PP | PP | PP |
| domain size of island component (μm) | 0.03~0.5 | 0.05~0.8 | 0.03~0.3 | 0.03~0.3 | 0.03~0.4 |
| area of streak-like grooves in fiber surface (%) | 5.0 | 7.8 | 3.9 | 3.8 | 3.8 |
| carboxyl end concentration (eq/ton) | 17 | 17 | 17 | 17 | 17 |
| fineness (dtex) | 225 | 225 | 225 | 225 | 225 |
| strength (cN/dtex) | 2.7 | 2.5 | 2.6 | 3.0 | 3.0 |
| rupture elongation (%) | 45 | 46 | 48 | 52 | 47 |
| U % (%) | 1.4 | 1.9 | 2.2 | 1.5 | 1.1 |
| boiling water shrinkage (%) | 6.0 | 6.6 | 6.1 | 6.0 | 6.3 |
| wear resistance (number of times of yarn breakage) | 88 | 72 | 76 | 103 | 95 |

Note:
PLLA and PP represent poly-L-lactic acid and polypropylene, respectively.

### Example 18

Six 225-decitex, 15-filament multifilaments produced as in Example 1 were paralleled to produce a 1350-decitex, 90-filament multifilament, which was processed in a crimper equipped with an air stuffing machine to prepare a BCF yarn. The first supply roll (non-heating type) was adjusted to a speed of 800 m/min to feed the yarn to the first heating roll. The first heating roll was adjusted to a circumferential speed of 808 m/min (percent stretch 1%) and a surface temperature of 145° C. After being heat-treated on the first heating roll, the yarn was fed continuously to the air stuffing machine with a nozzle temperature of 180° C., in which heat and air-pressure were applied for crimp formation to provide a three-dimensionally crimped yarn. It was taken off on a cooling drum and wound up with a wind-up tension of 120 g and wind-up speed of 768 m/min. The resulting crimped polymer alloy yarn consisted of 90 filaments and had a fineness of 1,380 decitex. With a crimp elongation of 15.5%, the yarn had good crimp properties. Furthermore, the crimped yarn was used to produce a carpet, which was then evaluated. The percent abrasion loss was 18.8%, indicating that the carpet had a high wear resistance. With a moderate bending strength, it was also pleasant to the touch.

### INDUSTRIAL APPLICABILITY

The polymer alloy fiber can be used as material for clothing that require wear resistance including, for instance, sportswear such as outdoor wear, golf wear, athletic wear, skiing wear, snow board wear, and pants used in combination with them; casual wear such as blouson; women's or men's outer clothing such as coat, heavy winter clothes, and rain wear; products that require long term durability and resistance to humid aging include uniforms, various covers, and other similar materials; and interior finishing material for automobiles, particularly including carpets for interior finishing of automobiles which require high wear resistance and resistance to humid aging.

1. A polymer alloy fiber comprising a polymer alloy consisting of a polylactic acid resin (A), a polyolefin resin (B), and a compatibilizer (C), wherein said compatibilizer (C) is an acrylic elastomer or an styrene elastomer containing at least one functional group selected from the group consisting of anhydride, carboxyl, amino, imino, alkoxysilyl, silanol, silyl ether, hydroxyl, and epoxy, and said polylactic acid resin (A) and said polyolefin resin (B) are island and sea components, respectively, to form a sea-island structure in the morphology of said polymer alloy.

2. The polymer alloy fiber as claimed in claim 1, wherein an area of streak-like grooves left in a fiber side face after alkali-etching the polymer alloy fiber accounts for 10% or less of the surface, where:
Percent area of streak-like grooves (%)=(area of streak-like grooves/fiber's surface area)×100.

3. The polymer alloy fiber as claimed in claim 1, wherein domain size of the island component is 0.005 to 2 μm.

4. The polymer alloy fiber as claimed in claim 1, wherein viscosity ratio (η_{A}/η_{B}) between melt viscosity η_{A} of the polylactic acid resin (A) and melt viscosity η_{B} of the polyolefin resin (B) is 1.3 to 10, said melt viscosities being measured at a temperature of 230° C. and a shear rate of 6.1 (sec⁻¹).

5. The polymer alloy fiber as claimed in claim 1, wherein both the polylactic acid resin (A) and the polyolefin resin (B) have a melting point of 150° C. or more.

6. The polymer alloy fiber as claimed in claim 1, wherein the composition of the polymer alloy is such that the polylactic acid resin (A), the polyolefin resin (B), and the compatibilizer (C) account for 1 to 45 parts by weight, 99 to 55 parts by weight, and 1 to 30 parts by weight, respectively, per 100 parts by weight accounted for by the total of the polylactic acid resin (A) and the polyolefin resin (B).

7. The polymer alloy fiber as claimed in claim 1, following properties:
Strength: 1 to 7 cN/dtex
Boiling water shrinkage: 0 to 10%.

8. A monofilament or a multifilament produced from a polymer alloy fiber as claimed in claim 1 having a yarn unevenness (U %, half-inert value) of 4% or less.

9. A fiber structure at least partly comprising a polymer alloy fiber as claimed in claim 1.

10. A fiber structure as claimed in claim 9, in the form of a carpet for automobile interior finishing.

11. A polymer alloy fiber production method comprising:
melting and kneading a polylactic acid resin (A), a polyolefin resin (B), and a compatibilizer (C);
feeding the blend to a spinning apparatus either after cooling and cutting into pellets or continuously in a molten state;
measuring the resin;
passing the resin through a multi-layered filter of metal nonwoven fabrics installed on the orifice;
discharging the resin through the orifice under the conditions of an orifice surface temperature of 210 to 230° C., an orifice back pressure of 1 to 5 MPa, and an average polymer flow rate in the orifice discharge hole of 0.03 to 0.30 m/sec to provide a monofilament or a multifilament;
cooling and oil-treating the monofilament or multifilament;
taking the monofilament or multifilament off at 300 m/min or more;
feeding the monofilament or multifilament to a stretching step after tentatively winding up or continuously;
stretching the monofilament or multifilament in a single stage or in two stages at a stretching temperature 60 to 140° C.; and
winding the monofilament or multifilament up;
wherein viscosity ratio (η_{A}/η_{B}) between the melt viscosity η_{A} of the polylactic acid resin (A) and melt viscosity η_{B} of the polyolefin resin (B) is in the range of 1.3 to 10, said melt viscosities being measured at a temperature of 230° C. and a shear rate of 6.1 (sec⁻¹), the melt viscosity η_{B} of the polyolefin resin (B) being 200 Pa·s or less, and the compatibilizer (C) is either an acrylic elastomer or a styrene elastomer containing at least one functional group selected from the group consisting of anhydride, carboxyl, amino, imino, alkoxysilyl, silanol, silyl ether, hydroxyl, and epoxy, that accounts for 1 to 30 parts by weight (calculated on the assumption that the total of the polylactic acid resin (A) and the polyolefin resin (B) accounts for 100 parts by weight).

12. A fiber structure at least partly comprising a filament as claimed in claim 8.

13. The polymer alloy fiber as claimed in claim 2, wherein domain size of the island component is 0.005 to 2 μm.

14. The polymer alloy fiber as claimed in claim 2, wherein viscosity ratio (η_{A}/η_{B}) between melt viscosity η_{A} of the polylactic acid resin (A) and melt viscosity η_{B} of the polyolefin resin (B) is 1.3 to 10, said melt viscosities being measured at a temperature of 230° C. and a shear rate of 6.1 (sec⁻¹).

15. The polymer alloy fiber as claimed in claim 3, wherein viscosity ratio (η_{A}/η_{B}) between melt viscosity η_{A} of the polylactic acid resin (A) and melt viscosity η_{B} of the polyolefin resin (B) is 1.3 to 10, said melt viscosities being measured at a temperature of 230° C. and a shear rate of 6.1 (sec⁻¹).

16. The polymer alloy fiber as claimed in claim 2, wherein both the polylactic acid resin (A) and the polyolefin resin (B) have a melting point of 150° C. or more.

17. The polymer alloy fiber as claimed in claim 3, wherein both the polylactic acid resin (A) and the polyolefin resin (B) have a melting point of 150° C. or more.

18. The polymer alloy fiber as claimed in claim 4, wherein both the polylactic acid resin (A) and the polyolefin resin (B) have a melting point of 150° C. or more.
